(19) United States
(12) Patent Application Publication
(10) Pub. No.: US 2021/0151740 A1
(43) Pub. Date: May 20, 2021

(54) POSITIVE ELECTRODE ACTIVE MATERIAL AND BATTERY INCLUDING THE SAME

(71) Applicant: Panasonic Intellectual Property Management Co., Ltd., Osaka (JP)

(72) Inventors: SHUHEI UCHIDA, Osaka (JP); RYUICHI NATSUI, Osaka (JP); KENSUKE NAKURA, Osaka (JP)

(21) Appl. No.: 17/159,245

(22) Filed: Jan. 27, 2021

Related U.S. Application Data
(63) Continuation of application No. PCT/JP2019/020001, filed on May 21, 2019.

(30) Foreign Application Priority Data
Sep. 5, 2018 (JP) 2018-166354

(51) Int. Cl. H01M 4/131; H01M 4/134; H01M 4/36; H01M 4/505; H01M 4/525; H01M 10/0525; C01G 53/00

(52) U.S. Cl. CPC H01M 4/131; H01M 4/134; H01M 4/366; H01M 4/364; H01M 2004/028; H01M 4/525; H01M 10/0525; C01G 53/50; H01M 4/505

(57) ABSTRACT

A positive electrode active material according to the present disclosure includes a lithium composite oxide that contains at least one element selected from the group consisting of F, Cl, N, and S, and at least one element selected from the group consisting of Bi, La, Ce, Ga, Sr, Y, and Sn. Mathematical formula 0.05≤integrated intensity ratio I_{(18°-20°)}/I_{(43°-46°)}≤0.90 is satisfied. The integrated intensity ratio I_{(18°-20°)}/I_{(43°-46°)} is a ratio of an integrated intensity I_{(18°-20°)} to an integrated intensity I_{(43°-46°)}. The integrated intensity I_{(A°-B°)}is an integrated intensity of a maximum peak present in a range of angle of diffraction 2θ greater than or equal to A° and less than or equal to B° in the X-ray diffraction pattern of the lithium composite oxide.

### BACKGROUND

### 1. Technical Field

The present disclosure relates to a positive electrode active material and a battery including the positive electrode active material.

### 2. Description of the Related Art

Japanese Unexamined Patent Application Publication No. 2016-26981 discloses a lithium-containing composite oxide essentially containing Li, Ni, Co, and Mn. The lithium composite oxide disclosed in Japanese Unexamined Patent Application Publication No. 2016-26981 has a space group R-3m and has a c-axis lattice constant in the range of 1.4208 to 1.4228 nanometers. The lithium composite oxide has a crystal structure with an a-axis lattice constant and a c-axis lattice constant that satisfies (3a+5.615)≤c≤(3a+5.655). Furthermore, in the lithium composite oxide, the integrated intensity ratio (I₀₀₃/I₁₀₄) of the (003) peak to the (104) peak in an X-ray diffraction pattern ranges from 1.21 to 1.39.

Japanese Unexamined Patent Application Publication No. 2013-156163 discloses a spinel-type lithium manganese oxide that has a chemical composition represented by the general formula Li₁₊ₓM_{y}Mn_{2-x-y}O₄, has a maximum particle size D₁₀₀ less than or equal to 15 μm, has a half-width less than or equal to 0.30 on the (400) plane in X-ray diffraction, and has a ratio I₄₀₀/I₁₁₁ greater than or equal to 0.33, where 1400 denotes the peak intensity of the (400) plane and I₁₁₁ denotes the peak intensity of the (111) plane. In Japanese Unexamined Patent Application Publication No. 2016-26981, M denotes at least one metallic element selected from the group consisting of Al, Co, Ni, Mg, Zr, and Ti, x is greater than or equal to 0 and less than or equal to 0.33, and y is greater than or equal to 0 and less than or equal to 0.2.

### SUMMARY

One non-limiting and exemplary embodiment provides a positive electrode active material for use in a long-life battery with a high capacity.

In one general aspect, the techniques disclosed here feature a positive electrode active material containing a lithium composite oxide. The lithium composite oxide contains at least one element selected from the group consisting of F, Cl, N, and S and at least one element selected from the group consisting of Bi, La, Ce, Ga, Sr, Y, and Sn, and the following mathematical formula (I) is satisfied: 0.05≤integrated intensity ratio I_{(18°-20°)}/I_{(43°-46°)}≤0.90 (I). The integrated intensity ratio I_{(18°-20°)}/I_{(43°-46°)}is a ratio of an integrated intensity I_{(18°-20°)}to an integrated intensity I_{(43°-46°)}. The integrated intensity I_{(43°-46°)} is an integrated intensity of a first peak that is a maximum peak present in a range of angle of diffraction 2θ greater than or equal to 43° and less than or equal to 46° in an X-ray diffraction pattern of the lithium composite oxide, and the integrated intensity I_{(16°-20°)} is an integrated intensity of a second peak that is a maximum peak present in a range of angle of diffraction 2θ greater than or equal to 18° and less than or equal to 20° in the X-ray diffraction pattern of the lithium composite oxide.

The present disclosure provides a positive electrode active material to produce a high-capacity and long-life battery. The present disclosure provides a battery that includes a positive electrode containing the positive electrode active material, a negative electrode, and an electrolyte. The battery has a high capacity and a long life.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery in a second embodiment;

FIG. 2 is a graph of powder X-ray diffraction patterns of positive electrode active materials according to Example 1 and Comparative Example 1; and

FIG. 3 is a graph of a change in capacity retention rate while charging and discharging of batteries according to Example 1 and Comparative Example 1 are performed multiple times.

### DETAILED DESCRIPTION

Embodiments of the present disclosure are described below.

### First Embodiment

A positive electrode active material according to a first embodiment contains a lithium composite oxide. The lithium composite oxide contains at least one element selected from the group consisting of F, Cl, N, and S, an at least one element selected from the group consisting of Bi, La, Ce, Ga, Sr, Y, and Sn, and the following mathematical formula (I) is satisfied: 0.05≤s integrated intensity ratio I_{(18°-20°)}/I_{(43°-46°)}≤0.90 (I). The integrated intensity ratio I_{(18°-20°)}/I_{(43°-46°)} is a ratio of an integrated intensity I_{(18°-20°)} to an integrated intensity I_{(43°-46°)}. The integrated intensity I_{(43°-46°)} is an integrated intensity of a first peak that is a maximum peak present in a range of angle of diffraction 2θ greater than or equal to 43° and less than or equal to 46° in an X-ray diffraction pattern of the lithium composite oxide, and the integrated intensity I_{(18°-20°)} is an integrated intensity of a second peak that is a maximum peak present in a range of angle of diffraction 2θ greater than or equal to 18° and less than or equal to 20° in the X-ray diffraction pattern of the lithium composite oxide.

The positive electrode active material according to the first embodiment is used to improve the capacity and life of a battery. The term “long-life battery”, as used herein, refers to a battery with a high discharge capacity retention rate even after repeated charge-discharge cycles.

A lithium-ion battery including the positive electrode active material according to the first embodiment has a redox potential (vs. Li/Li⁺) of approximately 3.4 V. The lithium-ion battery has a capacity greater than or equal to approximately 260 mAh/g. The lithium-ion battery has an energy density greater than or equal to approximately 3500 Wh/L. The lithium-ion battery may have an energy density greater than or equal to 4000 Wh/L. The term “the energy density of a battery”, as used herein, refers to a product of the initial discharge capacity (unit: mAh/g), the average operating voltage (unit: volt), and the true density of an active material (unit: g/cm³). Thus, a battery with a high energy density refers to a battery that has a high capacity, operates at high voltage, and contains a heavy active material.

The lithium composite oxide in the first embodiment except a lithium composite oxide (B) and a lithium composite oxide (C) described later contains at least one element selected from the group consisting of F, C, N, and S. The at least one element stabilizes the crystal structure of the lithium composite oxide. Oxygen atoms of the lithium composite oxide may be partly substituted with an electrochemically inactive anion. In other words, oxygen atoms may be partly substituted with at least one anion selected from the group consisting of F, Cl, N, and S. The substitution can stabilize the crystal structure. This can improve the discharge capacity or operating voltage of the battery and increase the energy density. The substitution of an anion with a large ionic radius for part of oxygen can widen the crystal lattice and improve Li diffusivity. A relatively high degree of cation mixing (for example, an integrated intensity ratio I_{(18°-20°)}/I_{(43°-46°)} greater than or equal to 0.05 and less than or equal to 0.90) also stabilizes the crystal structure. This enables a larger amount of Li to be intercalated and deintercalated and can improve the capacity of the battery.

The lithium composite oxide in the first embodiment has an integrated intensity ratio I_{(18°-20°)}/I_{(43°-46°)} greater than or equal to 0.05 and less than or equal to 0.90. The integrated intensity ratio I_{(18°-20°)}/I_{(43°-46°)} is a parameter that can be used as a measure of cation mixing in the lithium composite oxide. The term “cation mixing”, as used herein, refers to substitution between lithium ions and transition metal cations in a crystal structure of a lithium composite oxide. A decrease in the degree of cation mixing results in an increase in the integrated intensity ratio I_{(18°-20°)}/I_{(43°-46°)}. An increase in the degree of cation mixing results in a decrease in the integrated intensity ratio I_{(18°-20°)}/I_{(43°-46°)}.

An integrated intensity ratio I_{(18°-20°)}/I_{(43°-46°)} greater than or equal to 0.05 and less than or equal to 0.90 can result in sufficient cation mixing between lithium ions and transition metal cations in the lithium composite oxide in the first embodiment. Thus, the lithium composite oxide in the first embodiment has an increased number of three-dimensional diffusion paths of lithium. This enables a larger amount of Li to be intercalated and deintercalated. Thus, the lithium composite oxide in the first embodiment is more suitable for high-capacity batteries than known regularly ordered lithium composite oxides (that is, with a low degree of cation mixing).

To further improve the capacity of the battery, the integrated intensity ratio I_{(18°-20°)}/I_{(43°-46°)} may be greater than or equal to 0.11 and less than or equal to 0.85.

To further improve the capacity of the battery, the integrated intensity ratio I_{(18°-20°)}/I_{(43°-46°)} may be greater than or equal to 0.44 and less than or equal to 0.85.

To further improve the capacity of the battery, the integrated intensity ratio I_{(18°-20°)}/I_{(43°-46°)} may be greater than or equal to 0.44 and less than or equal to 0.70.

To further improve the capacity of the battery, the integrated intensity ratio I_{(18°-20°)}/I_{(43°-46°)} may be greater than or equal to 0.50 and less than or equal to 0.79.

The integrated intensity of an X-ray diffraction peak can be determined, for example, using software associated with an XRD apparatus (for example, PDXL (trade name) software associated with a powder X-ray diffractometer manufactured by Rigaku Corporation). The integrated intensity of an X-ray diffraction peak can be determined, for example, by calculating an area from the height and half-width of the X-ray diffraction peak.

In a crystal structure belonging to a space group C2/m in an XRD pattern with CuKα radiation, typically, a maximum peak present in a range of angle of diffraction angle 2θ greater than or equal to 18° and less than or equal to 20° reflects a (001) plane. A maximum peak present in a range of angle of diffraction angle 2θ greater than or equal to 43° and less than or equal to 46° reflects a (114) plane.

In a crystal structure belonging to the space group R-3m in an XRD pattern with CuKα radiation, typically, a maximum peak present in a range of angle of diffraction angle 2θ greater than or equal to 18° and less than or equal to 20° reflects a (003) plane. A maximum peak present in a range of angle of diffraction angle 2θ greater than or equal to 43° and less than or equal to 46° reflects a (104) plane.

In a crystal structure belonging to a space group Fm-3m in an XRD pattern with CuKα radiation, typically, there is no diffraction peak at a diffraction angle 2θ greater than or equal to 18° and less than or equal to 20° reflects a (001) plane. A maximum peak present in a range of angle of diffraction angle 2θ greater than or equal to 43° and less than or equal to 46° reflects a (200) plane.

In a crystal structure belonging to a space group Fd-3m in an XRD pattern with CuKα radiation, typically, a maximum peak present in a range of angle of diffraction angle 2θ greater than or equal to 18° and less than or equal to 20° reflects a (111) plane. A maximum peak present in a range of angle of diffraction angle 2θ greater than or equal to 43° and less than or equal to 46° reflects a (400) plane.

The lithium composite oxide in the first embodiment contains at least one element selected from the group consisting of Bi, La, Ce, Ga, Sr, Y, and Sn. For example, in a Li-excess positive electrode material containing a lithium composite oxide with a composition formula rich in lithium, it is considered that not only a transition metal in the crystal structure but also oxygen are involved in charge compensation and improve the capacity of the battery. However, it has been reported that part of oxygen involved in charge compensation is gasified and desorbs in the charge-discharge process and affects the performance. In the lithium composite oxide in the first embodiment, at least one heavy element selected from the group consisting of Bi, La, Ce, Ga, Sr, Y, and Sn substitutes for part of a transition metal. This can improve covalency between the heavy element and oxygen and reduce oxygen desorption in the charge-discharge process. Thus, it is thought that the positive electrode active material according to the first embodiment has a high discharge capacity retention rate even after repeated charging and discharging.

To further increase the discharge capacity retention rate after repeated charging and discharging, the lithium composite oxide in the first embodiment may contain at least one element selected from the group consisting of Bi, La, and Ce.

The lithium composite oxide in the first embodiment may contain Bi.

Bi, which has a large atomic number, at a transition metal site in the lithium composite oxide has high affinity to oxygen. This further decreases the amount of oxygen to be gasified in the charge-discharge process. This can further suppress oxygen desorption while charging and discharging and stabilize the crystal structure. Bi is a heavy element and therefore also improves the energy density per unit volume of the positive electrode active material. Thus, a lithium composite oxide containing Bi can have a further increased discharge capacity retention rate after repeated charging and discharging.

The lithium composite oxide in the first embodiment may contain F.

The substitution of a fluorine atom, which has high electronegativity, for part of oxygen can increase the interaction between a cation and an anion and improve the discharge capacity or operating voltage. For the same reason, solid solution of F localizes electrons as compared with lithium composite oxides without F. This can suppress oxygen desorption while charging and stabilize the crystal structure. A relatively high degree of cation mixing (for example, an integrated intensity ratio greater than or equal to 0.05 and less than or equal to 0.90) also stabilizes the crystal structure. This enables a larger amount of Li to be intercalated and deintercalated. A combination of these effects can further improve the capacity of the battery.

In the first embodiment, the lithium composite oxide contains not only a lithium atom but also another type of atom. Examples of the other type of atom include Mn, Co, Ni, Fe, Cu, V, Nb, Mo, Ti, Cr, Zr, Zn, Na, K, Ca, Mg, Pt, Au, Ag, Ru, W, B, Si, P, and Al. The lithium composite oxide may contain a type of atom other than the lithium atom. Alternatively, the lithium composite oxide may contain two or more types of atoms other than the lithium atom.

To further improve the capacity of the battery, the lithium composite oxide may contain at least one element selected from the group consisting of Mn, Co, Ni, Fe, Cu, V, Nb, Ti, Cr, Ru, W, B, Si, P, and Al.

To further improve the capacity of the battery, in the first embodiment, the lithium composite oxide may contain at least one 3d transition metal element selected from the group consisting of Mn, Co, Ni, Fe, Cu, V, Ti, Cr, and Zn.

In the first embodiment, the lithium composite oxide may contain Mn.

A hybrid orbital of Mn and oxygen is easily formed and suppresses oxygen desorption while charging. This stabilizes the crystal structure and further improves the capacity of the battery.

To further improve the capacity of the battery, in the first embodiment, the lithium composite oxide may contain at least one element selected from the group consisting of Mn, Co, and Ni.

Such a lithium composite oxide contains a transition metal that can easily form a hybrid orbital with oxygen, and the hybrid orbital can suppress oxygen desorption while charging. This can stabilize the crystal structure and improve the capacity and energy density of the battery.

The lithium composite oxide in the first embodiment may contain not only Mn but also at least one element selected from the group consisting of Co, Ni, Fe, Al, Cu, V, Nb, Mo, Ti, Cr, Zr, Zn, Na, K, Ca, Mg, Pt, Au, Ag, Ru, W, B, Si, and P.

The at least one element can more effectively suppress oxygen desorption while charging as compared with lithium composite oxides containing only Mn as a cation element other than Li. This can stabilize the crystal structure and further improve the capacity and energy density of the battery.

The lithium composite oxide in the first embodiment may contain Co and Ni in addition to Mn.

Mn easily forms a hybrid orbital with oxygen. Co stabilizes the crystal structure. Ni promotes the deintercalation of Li. These three effects can further stabilize the crystal structure and improve the capacity of the battery.

An example of the chemical composition of the lithium composite oxide in the first embodiment is described below.

The lithium composite oxide in the first embodiment may have an average composition represented by the following composition formula (I):

Liₓ(A_{z}Me_{1-z})_{y}O_{α}Q_{β} (1),

where A denotes at least one element selected from the group consisting of Bi, La, Ce, Ga, Sr, Y, and Sn,

Me denotes at least one element selected from the group consisting of Mn, Co, Ni, Fe, Cu, V, Nb, Mo, Ti, Cr, Zr, Zn, Na, K, Ca, Mg, Pt, Au, Ag, Ru, W, B, Si, P, and Al,

Q denotes at least one element selected from the group consisting of F, Cl, N, and S, and

the following five mathematical formulas are satisfied:

0.5≤x≤1.5,

0.5≤y≤1.0,

0<z≤0.3,

1≤α<2, and

0<β≤1.

The lithium composite oxide improves the capacity of the battery.

Me may include at least one element selected from the group consisting of Mn, Co, Ni, Fe, Cu, V, Ti, Cr, and Zn (that is, at least one 3d transition metal element).

The “average composition” of the lithium composite oxide is determined by analyzing the elements of the lithium composite oxide without considering a difference in the composition of each phase of the lithium composite oxide. Typically, it means the composition determined by the elemental analysis of a sample greater than or equal to the primary particle size of the lithium composite oxide. A first phase and a second phase may have the same chemical composition. Alternatively, the first phase and the second phase may have different compositions.

The average composition can be determined by inductively coupled plasma spectroscopy, an inert gas fusion-infrared absorption method, ion chromatography, or a combination of these analysis methods.

For A represented by the chemical formula A′_{z1}A″_{z2}, “z=z1+z2” is satisfied. For example, for A represented by Bi_{0.05}La_{0.05}, “z=0.05+0.05=0.1”. Me and Q each independently composed of two or more elements can be calculated in the same manner as in A.

An x value greater than or equal to 1.05 results in an increased amount of Li to be intercalated into and deintercalated from the positive electrode active material. This improves the capacity.

At an x value less than or equal to 1.5, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure and improves the capacity.

At a y value greater than or equal to 0.5, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

A y value less than or equal to 1.0 results in an increased amount of Li to be intercalated into and deintercalated from the positive electrode active material and an improved capacity.

A z value greater than or equal to 0.005 results in further suppressed oxygen desorption in the charge-discharge process and an increased discharge capacity retention rate after repeated charging and discharging.

At a z value less than or equal to 0.2, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure and improves the capacity.

An α value greater than or equal to 1 can result in the prevention of a decrease in the amount of charge compensation due to oxidation-reduction of oxygen. This improves the capacity.

An α value less than 2.0 results in the prevention of excess capacity due to oxidation-reduction of oxygen and results in stabilization of the crystal structure when Li is deintercalated. This improves the capacity.

A β value greater than 0 results in a stably maintained crystal structure due to the electrochemically inactive effects of Q even after Li is deintercalated. This improves the capacity.

A β value less than or equal to 1 can result in the prevention of an increase in the electrochemically inactive effects of Q and improved electronic conductivity. This improves the capacity.

To further improve the capacity and life of the battery, the following four mathematical formulas may be satisfied:

1.05≤x≤1.4,

0.6≤y≤0.95,

1.2≤α<2, and

0<β≤0.8.

To further improve the capacity and life of the battery, the following two conditions may be satisfied:

1.33≤α<2 and

0<β≤0.67.

To further improve the capacity and life of the battery, the following four conditions may be satisfied:

1.15≤x≤1.3,

0.7≤y≤0.85,

1.8≤α≤1.95, and

0.05≤β≤0.2.

A z value may be less than or equal to 0.2, less than or equal to 0.15, or less than or equal to 0.125. A z value may be greater than or equal to 0.005, greater than or equal to 0.01, or greater than or equal to 0.0125.

To further improve the capacity of the battery, Me may contain at least one element selected from the group consisting of Mn, Co, Ni, Fe, Cu, V, Nb, Ti, Cr, Na, Mg, Ru, W, B, Si, P, and Al.

Me may contain Mn. Thus, Me may be Mn.

Me may contain not only Mn but also at least one element selected from the group consisting of Co, Ni, Fe, Cu, V, Nb, Mo, Ti, Cr, Zr, Zn, Na, K, Ca, Mg, Pt, Au, Ag, Ru, W, B, Si, P, and Al.

As described above, Mn easily forms a hybrid orbital with oxygen and therefore can suppress oxygen desorption while charging. A relatively high degree of cation mixing (for example, an integrated intensity ratio I_{(18°-20°)}/I_{(43°-46°)} greater than or equal to 0.05 and less than or equal to 0.90) can also stabilize the crystal structure and further improve the capacity of the battery.

Me may contain Co and Ni in addition to Mn.

Mn easily forms a hybrid orbital with oxygen. Co stabilizes the crystal structure. Ni promotes the deintercalation of Li. These three effects further stabilize the crystal structure and further improve the capacity of the battery.

In the lithium composite oxide in the first embodiment, Li may partly be substituted with an alkali metal, such as Na or K.

The positive electrode active material according to the first embodiment may contain the lithium composite oxide as a main component. In other words, in the positive electrode active material according to the first embodiment, the mass ratio of the lithium composite oxide to the positive electrode active material may be greater than or equal to 50%. Such a positive electrode active material further improves the capacity of the battery.

To further improve the capacity of the battery, the mass ratio may be greater than or equal to 70%.

To further improve the capacity of the battery, the mass ratio may be greater than or equal to 90%.

The positive electrode active material according to the first embodiment may contain incidental impurities in addition to the lithium composite oxide.

The positive electrode active material according to the first embodiment may contain its starting materials as unreacted materials. The positive electrode active material according to the first embodiment may contain a by-product produced during the synthesis of the lithium composite oxide. The positive electrode active material according to the first embodiment may contain a decomposition product produced by the decomposition of the lithium composite oxide.

The positive electrode active material according to the first embodiment may contain the lithium composite oxide alone except incidental impurities.

A positive electrode active material containing the lithium composite oxide alone can further improve the capacity of the battery.

The crystal structure of the lithium composite oxide in the first embodiment is described below. The characteristics of the lithium composite oxide in the first embodiment (for example, the relationship between the integrated intensity ratio I_{(18°-20°)}/I_{(43°-46°)} and the lithium composite oxide) are also described in more detail.

The lithium composite oxide in the first embodiment does not have a limited crystal structure. To further improve the capacity of the battery, for example, the lithium composite oxide in the first embodiment may have a crystal structure belonging to a layered structure or a spinel structure.

The lithium composite oxide in the first embodiment may have a layered structure. When the lithium composite oxide in the first embodiment has a layered structure, the crystal structure belonging to the layered structure may be a crystal structure belonging to at least one space group selected from the group consisting of the space group C2/m and the space group R-3m.

The crystal structure belonging to the layered structure may be a hexagonal crystal structure or a monoclinic crystal structure. This improves the Li diffusivity and improves the capacity of the battery.

The lithium composite oxide in the first embodiment may have a spinel structure. When the lithium composite oxide in the first embodiment has the spinel structure, the lithium composite oxide has a crystal structure belonging to the space group Fd-3m, for example.

To further improve the capacity of the battery, the lithium composite oxide in the first embodiment may be a multiphase mixture that has a first phase with a crystal structure belonging to the space group Fm-3m and a second phase with a crystal structure belonging to a space group other than the space group Fm-3m (for example, a crystal structure belonging to at least one space group selected from the group consisting of the space group Fd-3m, the space group R-3m, and the space group C2/m).

Examples of the lithium composite oxide in the first embodiment include three lithium composite oxides of the following (A) to (C):

(A) a lithium composite oxide with a layered structure (that is, a crystal structure belonging to at least one space group selected from the group consisting of the space group C2/m and the space group R-3m),

(B) a lithium composite oxide with a spinel structure (that is, a crystal structure belonging to the space group Fd-3m), and

(C) a lithium composite oxide formed of a multiphase mixture that has a first phase with a crystal structure belonging to the space group Fm-3m and a second phase with a crystal structure belonging to a space group other than the space group Fm-3m (for example, a crystal structure belonging to at least one space group selected from the group consisting of the space group Fd-3m, the space group R-3m, and the space group C2/m).

The lithium composite oxides of the (A), (B), and (C) are hereinafter referred to as a “lithium composite oxide (A)”, a “lithium composite oxide (B)”, and a “lithium composite oxide (C)”, respectively. The description of a “lithium composite oxide” without distinction of (A) to (C) applies to a lithium composite oxide with any crystal structure in the first embodiment.

The space group of the lithium composite oxide in the first embodiment can be identified not only by X-ray diffractometry but also by observing an electron diffraction pattern using a known electron diffraction technique with a transmission electron microscope (hereinafter referred to as a “TEM”).

### <Lithium Composite Oxide (A)>

The lithium composite oxide (A) has an integrated intensity ratio I_{(18°-20°)}/I_{(43°-46°)} greater than or equal to 0.05 and less than or equal to 0.90.

In the lithium composite oxide (A), an integrated intensity ratio I_{(18°-20°)}/I_{(43°-46°)} less than 0.05 results in an excessively high Li occupancy in a transition metal layer and a thermodynamically unstable crystal structure. This results in the deintercalation of Li while charging, which causes the crystal structure to collapse and results in insufficient capacity.

In the lithium composite oxide (A), an integrated intensity ratio I_{(18°-20°)}/I_{(43°-46°)} greater than 0.90 results in a lower degree of cation mixing, a lower Li occupancy in the transition metal layer, and a decreased number of three-dimensional diffusion paths of Li. This reduces the Li diffusivity and results in insufficient capacity.

Thus, an integrated intensity ratio I_{(18°-20°)}/I_{(43°-46°)} greater than or equal to 0.05 and less than or equal to 0.90 can result in sufficient cation mixing between lithium ions and transition metal cations in the lithium composite oxide (A). Consequently, in the lithium composite oxide (A), it is thought that an increased number of three-dimensional diffusion paths of lithium enables a larger amount of Li to be intercalated and deintercalated.

In the lithium composite oxide (A), an integrated intensity ratio I_{(18°-20°)}/I_{(43°-46°)} greater than or equal to 0.05 and less than or equal to 0.90 results in not only high Li diffusivity in the Li layer but also improved Li diffusivity in the transition metal layer. This also improves Li diffusivity between the Li layer and the transition metal layer. Thus, the lithium composite oxide (A) is more suitable for high-capacity batteries than known regularly ordered lithium composite oxides (that is, lithium composite oxides with a low degree of cation mixing).

Japanese Unexamined Patent Application Publication No. 2016-26981 discloses a positive electrode active material containing a lithium composite oxide that has a crystal structure belonging to the space group R-3m, which is a layered structure, and that includes insufficient cation mixing between lithium atoms and transition metal cations. As disclosed in Japanese Unexamined Patent Application Publication No. 2016-26981, it has been believed in the related art that cation mixing in a lithium composite oxide should be suppressed.

The lithium composite oxide (A) contains at least one element selected from the group consisting of F, C, N, and S. An integrated intensity ratio I_{(18°-20°)}/I_{(43°-46°)} greater than or equal to 0.05 and less than or equal to 0.90 can result in a further improved capacity of the battery.

The lithium composite oxide (A) may be

a single-phase lithium composite oxide (A1) with a crystal structure belonging to the space group C2/m,

a single-phase lithium composite oxide (A2) with a crystal structure belonging to the space group R-3m, or

a multiphase lithium composite oxide (A3) that has a phase with a crystal structure belonging to the space group C2/m (that is, a C2/m phase) and a phase with a crystal structure belonging to the space group R-3m (that is, an R-3m phase).

### Lithium Composite Oxide (A1)

The lithium composite oxide (A1) is described below. In the lithium composite oxide (A1), it is thought that an integrated intensity ratio I_{(18°-20°)}/I_{(43°-46°)} greater than or equal to 0.05 and less than or equal to 0.90 results in a Li occupancy in “the total of 2b site and 4g site” corresponding to the transition metal layer, for example, greater than or equal to 25% by mole and less than 50% by mole. This results in not only high Li diffusivity in the Li layer but also improved Li diffusivity in the transition metal layer. This also improves Li diffusivity between the Li layer and the transition metal layer. Thus, the lithium composite oxide (A) is more suitable for high-capacity batteries than known regularly ordered lithium composite oxides (that is, lithium composite oxides with a low degree of cation mixing).

In the lithium composite oxide (A1), which has the crystal structure belonging to the space group C2/m and has an integrated intensity ratio I_{(18°-20°)}/I_{(43°-46°)} greater than or equal to 0.05 and less than or equal to 0.90, a transition metal anion octahedral three-dimensional network is formed. The three-dimensional network functions as a pillar when a large amount of Li is removed. Consequently, the crystal structure can be stably maintained. Thus, a positive electrode active material containing the lithium composite oxide (A1) is suitable for high-capacity batteries. For the same reason, a positive electrode active material containing the lithium composite oxide (A1) is also suitable for batteries with good cycle characteristics.

The crystal structure belonging to the space group C2/m can more easily maintain the layered structure than a layered structure belonging to the space group R-3m when a large amount of Li is removed. Thus, the crystal structure belonging to the space group C2/m is less likely to collapse.

To further improve the capacity of the battery, the lithium composite oxide (A1) may have an integrated intensity ratio I_{(18°-20°)}/I_{(43°-46°)} greater than or equal to 0.11 and less than or equal to 0.85.

To further improve the capacity of the battery, the lithium composite oxide (A1) may have an integrated intensity ratio I_{(18°-20°)}/I_{(43°-46°)} greater than or equal to 0.44 and less than or equal to 0.85.

To further improve the capacity of the battery, in the lithium composite oxide (A1), the following four mathematical formulas may be satisfied:

1.05≤x≤1.4,

0.6≤y≤0.95,

1.33≤α<2, and

0<β≤0.67.

An x value greater than or equal to 1.05 results in an increased amount of Li to be intercalated into and deintercalated from the positive electrode active material. This improves the capacity.

At an x valueless than or equal to 1.4, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

At a y value greater than or equal to 0.6, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

A y valueless than or equal to 0.95 results in an increased amount of Li to be intercalated into and deintercalated from the positive electrode active material. This improves the capacity.

An α value greater than or equal to 1.33 results in the prevention of a decrease in the amount of charge compensation due to oxidation-reduction of oxygen. This improves the capacity.

An α value less than 2.0 results in the prevention of excess capacity due to oxidation-reduction of oxygen and results in stabilization of the crystal structure when Li is deintercalated. This improves the capacity.

A β value greater than 0 results in a stably maintained crystal structure due to the electrochemically inactive effects of Q even after Li is deintercalated. This improves the capacity.

A β value less than or equal to 0.67 results in the prevention of an increase in the electrochemically inactive effects of Q and improved electronic conductivity. This improves the capacity.

To further improve the capacity of the battery, in the lithium composite oxide (A1), the following four mathematical formulas may be satisfied:

1.15≤x≤1.3,

0.7≤y≤0.85,

1.8≤α≤1.95, and

0.05≤β≤0.2.

The mole ratio of Li to (A+Me) is represented by the mathematical formula (x/y).

To further improve the capacity of the battery, the mole ratio (x/y) may be greater than or equal to 1.3 and less than or equal to 1.9.

A mole ratio (x/y) greater than 1 results in, for example, a ratio of the number of Li atoms in the lithium composite oxide in the positive electrode active material according to the first embodiment higher than the ratio of the number of Li atoms in a known positive electrode active material represented by the composition formula LiMnO₂. This enables a larger amount of Li to be intercalated and deintercalated.

A mole ratio (x/y) greater than or equal to 1.3 results in an increased amount of available Li and therefore the formation of appropriate Li diffusion paths. Thus, a mole ratio (x/y) greater than or equal to 1.3 results in a further improved capacity of the battery.

A mole ratio (x/y) less than or equal to 1.9 can result in the prevention of less oxidation-reduction reaction of available Me. This obviates the need to increase the utilization of an oxidation-reduction reaction of oxygen. This suppresses a decrease in the Li intercalation efficiency while discharging caused by destabilization of the crystal structure due to the deintercalation of Li while charging. This further improves the capacity of the battery.

To further improve the capacity of the battery, the mole ratio (x/y) may be greater than or equal to 1.3 and less than or equal to 1.7.

The mole ratio of O to Q is represented by the mathematical formula (α/β).

To further improve the capacity of the battery, the mole ratio (α/β) may be greater than or equal to 9 and less than or equal to 39.

A mole ratio (α/β) greater than or equal to 9 results in the prevention of a decrease in the amount of charge compensation due to oxidation-reduction of oxygen. This can also reduce the effects of electrochemically inactive Q and improves electronic conductivity. This further improves the capacity of the battery.

A mole ratio (α/β) less than or equal to 39 can result in the prevention of excess capacity due to oxidation-reduction of oxygen. This stabilizes the crystal structure when Li is deintercalated. Due to the effects of electrochemically inactive Q, this also stabilizes the crystal structure when Li is deintercalated. Thus, the battery can have a higher capacity.

To further improve the capacity of the battery, the mole ratio (α/β) may be greater than or equal to 9 and less than or equal to 19.

As described above, the lithium composite oxide may have an average composition represented by the composition formula Liₓ(A_{z}Me_{1-z})_{y}O_{α}Q_{β}. Thus, the lithium composite oxide is composed of a cation moiety and an anion moiety. The cation moiety is composed of Li, A, and Me. The anion moiety is composed of O and Q. The mole ratio of the cation moiety composed of Li, A, and Me to the anion moiety composed of O and Q is represented by the mathematical formula ((x+y)/(α+β)).

To further improve the capacity of the battery, the mole ratio ((x+y)/(α+β)) may be greater than or equal to 0.75 and less than or equal to 1.2.

A mole ratio ((x+y)/(α+β)) greater than or equal to 0.75 can result in the prevention of large amounts of impurities produced during the synthesis of the lithium composite oxide and a further improved capacity of the battery.

A mole ratio ((x+y)/(α+β)) less than or equal to 1.2 results in a decreased loss of the anion moiety of the lithium composite oxide and a stably maintained crystal structure even after lithium is deintercalated from the lithium composite oxide by charging.

To further improve the capacity and cycle characteristics of the battery, the mole ratio ((x+y)/(a+R)) may be greater than or equal to 0.75 and less than or equal to 1.0.

A mole ratio ((x+y)/(α+β)) less than or equal to 1.0 results in a cation deficiency in the crystal structure and increased Li diffusion paths. This improves the capacity of the battery. Due to randomly arranged cation deficiencies in the initial state, the crystal structure does not become unstable when Li is deintercalated. This results in a long-life battery with good cycle characteristics.

In the lithium composite oxide (A1), the mole ratio of Mn to Me may be greater than or equal to 60%. In other words, the mole ratio of Mn to Me including Mn (that is, the Mn/Me mole ratio) may be greater than or equal to 0.6 and less than or equal to 1.0.

At a mole ratio greater than or equal to 0.6 and less than or equal to 1.0, sufficient Mn that can easily form a hybrid orbital with oxygen further suppresses oxygen desorption while charging. This stabilizes the crystal structure and improves the capacity of the battery.

Me may contain Co and Ni in addition to Mn.

Mn easily forms a hybrid orbital with oxygen. Co stabilizes the crystal structure. Ni promotes the deintercalation of Li. These three effects can further stabilize the crystal structure and improve the capacity of the battery.

Me may contain at least one element selected from the group consisting of B, Si, P, and Al such that the mole ratio of the at least one element to Me is less than or equal to 20%.

B, Si, P, and Al, which have high covalency, stabilize the crystal structure of the lithium composite oxide. Thus, they improve cycle characteristics and extend the life of the battery.

Lithium Composite Oxide (A2)

The lithium composite oxide (A2) is described below. To improve the capacity and energy density of the battery, the lithium composite oxide (A2) may have an integrated intensity ratio I_{(18°-20°)}/I_{(43°-46°)} greater than or equal to 0.62 and less than or equal to 0.90.

An integrated intensity ratio I_{(18°-20°)}/I_{(43°-46°)} greater than 0.90 results in a decreased number of three-dimensional diffusion paths of lithium due to suppressed cation mixing. This hinders the diffusion of lithium and decreases the capacity and energy density.

An integrated intensity ratio I_{(18°-20°)}/I_{(43°-46°)} less than 0.62 results in an unstable crystal structure. This causes the crystal structure to collapse due to the deintercalation of Li while charging and decreases the capacity and energy density.

In the lithium composite oxide (A2), which has an integrated intensity ratio I_{(18°-20°)}/I_{(43°-46°)} greater than or equal to 0.62 and less than or equal to 0.90, it is thought that sufficient cation mixing occurs between lithium ions and transition metal cations. This can increase the number of three-dimensional diffusion paths of lithium. Thus, the lithium composite oxide in the first embodiment enables a larger amount of Li to be intercalated and deintercalated than known positive electrode active materials.

In the lithium composite oxide (A2), which has the crystal structure belonging to the space group R-3m and has an integrated intensity ratio I_{(18°-20°)}/I_{(43°-46°)} greater than or equal to 0.62 and less than or equal to 0.90, a transition metal anion octahedral three-dimensional network is formed. The three-dimensional network functions as a pillar when a large amount of Li is removed. Consequently, the crystal structure can be stably maintained. Thus, a positive electrode active material containing the lithium composite oxide (A2) is suitable for high-capacity batteries. For the same reason, a positive electrode active material containing the lithium composite oxide (A2) is also suitable for batteries with good cycle characteristics.

To increase the energy density of the battery, the lithium composite oxide (A2) may have an integrated intensity ratio I_{(18°-20°)}/I_{(43°-46°)} greater than or equal to 0.67 and less than or equal to 0.85.

To increase the energy density of the battery, the lithium composite oxide (A2) may have an α greater than or equal to 1.67 and less than or equal to 1.95.

To increase the energy density of the battery, the lithium composite oxide (A2) may have a β value greater than or equal to 0.05 and less than or equal to 0.33.

To increase the energy density of the battery, the lithium composite oxide (A2) may have a mole ratio (x/y) greater than or equal to 0.5 and less than or equal to 3.0.

A mole ratio (x/y) greater than or equal to 0.5 results in an increased amount of available Li and therefore the formation of appropriate Li diffusion paths. This further improves the energy density of the battery. A mole ratio (x/y) less than or equal to 3.0 results in the prevention of less oxidation-reduction reaction of available Me. This obviates the need to increase the utilization of an oxidation-reduction reaction of oxygen. This suppresses a decrease in the Li intercalation efficiency while discharging caused by destabilization of the crystal structure due to the deintercalation of Li while charging. This further improves the energy density of the battery.

The lithium composite oxide (A2) may have a mole ratio (x/y) greater than or equal to 1.5 and less than or equal to 2.0.

A mole ratio (x/y) greater than or equal to 1.5 and less than or equal to 2.0 results in a larger proportion of the number of Li atoms at the Li site than that in known positive electrode active materials (for example, LiMnO₂). This enables a larger amount of Li to be intercalated and deintercalated and can improve the energy density of the battery.

To increase the energy density of the battery, the lithium composite oxide (A2) may have a mole ratio (ad) greater than or equal to 5 and less than or equal to 39.

A mole ratio (α/β) greater than or equal to 5 results in the prevention of a decrease in the amount of charge compensation due to oxidation-reduction of oxygen. This can also reduce the effects of electrochemically inactive Q and improves electronic conductivity. This further improves the capacity of the battery.

A mole ratio (α/β) less than or equal to 39 can result in the prevention of excess capacity due to oxidation-reduction of oxygen. This stabilizes the crystal structure when Li is deintercalated. Due to the effects of electrochemically inactive Q, this also stabilizes the crystal structure when Li is deintercalated. This further improves the capacity of the battery.

To increase the energy density of the battery, the lithium composite oxide (A2) may have a mole ratio (α/β) greater than or equal to 9 and less than or equal to 19.

To increase the energy density of the battery, the lithium composite oxide (A2) may have a mole ratio ((x+y)/(a+0)) greater than or equal to 0.75 and less than or equal to 1.15.

A mole ratio ((x+y)/(α+β)) greater than or equal to 0.75 can result in the prevention of large amounts of impurities produced during the synthesis of the lithium composite oxide and a further improved capacity of the battery. A mole ratio ((x+y)/(α+β)) less than or equal to 1.15 results in a decreased loss of the anion moiety of the lithium composite oxide and a stably maintained crystal structure even after lithium is deintercalated from the lithium composite oxide by charging.

In the lithium composite oxide (A2), the mole ratio of Mn to Me may be greater than or equal to 40%. In other words, the mole ratio of Mn to Me including Mn may be greater than or equal to 0.4 and less than or equal to 1.0.

At a mole ratio greater than or equal to 0.4 and less than or equal to 1.0, sufficient Mn that can easily form a hybrid orbital with oxygen further suppresses oxygen desorption while charging. This stabilizes the crystal structure and improves the energy density of the battery.

### Lithium Composite Oxide (A3)

The lithium composite oxide (A3) is described below. The lithium composite oxide (A3) has the C2/m phase with the crystal structure belonging to the space group C2/m and the R-3m phase with the crystal structure belonging to the space group R-3m.

The crystal structure belonging to the space group C2/m has a structure that includes alternately stacked Li layers and transition metal layers. The transition metal layer may contain Li in addition to a transition metal. Thus, a larger amount of Li is intercalated in the crystal structure belonging to the space group C2/m than in a known commonly used material LiCoO₂.

However, it is thought that a transition metal layer formed only of the crystal structure belonging to the space group C2/m has a high Li migration barrier (that is, low Li diffusivity) and has a decreased capacity in fast charging.

The crystal structure belonging to the space group R-3m has a two-dimensional Li diffusion path. Thus, the crystal structure belonging to the space group R-3m has high Li diffusivity.

The lithium composite oxide (A3) has both the crystal structure belonging to the space group C2/m and the crystal structure belonging to the space group R-3m and can therefore achieve a high-capacity battery. The battery can be suitable for fast charging.

The lithium composite oxide (A3) may have three-dimensionally randomly arranged regions formed of the C2/m phase and regions formed of the R-3m phase.

The three-dimensional random arrangement expands the three-dimensional diffusion paths of Li and can therefore intercalate and deintercalate a larger amount of lithium. This improves the capacity of the battery.

As described above, whether the lithium composite oxide is a multiphase mixture or not can be determined by X-ray diffractometry and electron diffractometry. More specifically, in a spectrum of the lithium composite oxide obtained by X-ray diffractometry and electron diffractometry, a peak with the characteristics of a plurality of phases indicates that the lithium composite oxide is a multiphase mixture.

The lithium composite oxide (A3) may satisfy the following mathematical formula (II):

0.05≤integrated intensity ratio I_{(20°-23°)}/I_{(18°-20°)}≤0.26 (II),

where the integrated intensity ratio I_{(20°-23°)}/I_{(18°-20°)} is the ratio of the integrated intensity I_{(20°-23°)} to the integrated intensity I_{(18°-20°)}, and the integrated intensity I_{(20°-23°)} is the integrated intensity of a third peak that is a maximum peak present in a range of angle of diffraction 2θ greater than or equal to 20° and less than or equal to 23° in an X-ray diffraction pattern of the lithium composite oxide.

The integrated intensity ratio I_{(20°-23°)}/I_{(18°-20°)} is a parameter that can be used as a measure of the abundance ratio of the C2/m phase or R-3m phase in the lithium composite oxide (A3). It is thought that an increase in the abundance ratio of the C2/m phase results in an increase in the integrated intensity ratio I_{(20°-23°)}/I_{(18°-20°)}. It is thought that an increase in the abundance ratio of the R-3m phase results in a decrease in the integrated intensity ratio I_{(20°-23°)}/I_{(18°-20°)}.

It is thought that an integrated intensity ratio I_{(20°-23°)}/I_{(18°-20°)} greater than or equal to 0.05 results in an increase in the abundance ratio of the C2/m phase and therefore an increase in the amounts of intercalated and deintercalated Li while charging and discharging. This can further improve the capacity of the battery.

It is thought that an integrated intensity ratio I_{(20°-23°)}/I_{(18°-20°)} less than or equal to 0.26 results in an increase in the abundance ratio of the R-3m phase and therefore improved Li diffusivity. This can further improve the capacity of the battery.

Thus, in the lithium composite oxide (A3), it is thought that an integrated intensity ratio I_{(20°-23°)}/I_{(18°-20°)} or greater than or equal to 0.05 and less than or equal to 0.26 results in a large amount of Li to be intercalated and deintercalated and high Li diffusivity. Consequently, the lithium composite oxide (A3) can be used to produce a high-capacity battery.

### <Lithium Composite Oxide (B)>

The lithium composite oxide (B) is described below. The lithium composite oxide (B) has a spinel structure, that is, a crystal structure belonging to the space group Fd-3m. Because the integrated intensity ratio I_{(18°-20°)}/I_{(43°-43°)} is greater than or equal to 0.05 and less than or equal to 0.90, it is thought that the lithium composite oxide (B) also has a relatively high degree of cation mixing. Thus, cation mixing between lithium ions and transition metal cations probably occurs in all the “8a sites, 16d sites, and 16c sites” corresponding to cation sites in the Li layer and the transition metal layer. The Li occupancies at the 8a sites, 16d sites, and 16c sites are not particularly limited, provided that the integrated intensity ratio I_{(18°-20°)}/I_{(43°-46°)} is greater than or equal to 0.05 and less than or equal to 0.90.

In the lithium composite oxide (B), the cation mixing improves Li diffusivity not only in the Li layer but also in the transition metal layer. This also improves Li diffusivity between the Li layer and the transition metal layer. In other words, Li can efficiently diffuse at all cation sites. Thus, the lithium composite oxide (B) in the first embodiment is more suitable for high-capacity batteries than known regularly ordered lithium composite oxides (that is, with a low degree of cation mixing).

An integrated intensity ratio I_{(18°-20°)}/I_{(43°-46°)} less than 0.05 results in an excessively high Li occupancy in the transition metal layer and a thermodynamically unstable crystal structure. This results in the deintercalation of Li while charging, which causes the crystal structure to collapse and results in insufficient capacity.

An integrated intensity ratio I_{(18°-20°)}/I_{(43°-46°)} greater than 0.90 results in a lower degree of cation mixing, a lower Li occupancy in the transition metal layer, and a decreased number of three-dimensional diffusion paths of Li. This reduces the Li diffusivity and results in insufficient capacity.

An integrated intensity ratio I_{(18°-20°)}/I_{(43°-46°)} greater than or equal to 0.05 and less than or equal to 0.90 can result in sufficient cation mixing between lithium ions and transition metal cations in the lithium composite oxide (B). Consequently, in the lithium composite oxide (B), it is thought that an increased number of three-dimensional diffusion paths of lithium enables a larger amount of Li to be intercalated and deintercalated.

In the lithium composite oxide (B), which has the crystal structure belonging to the space group Fd-3m and has an integrated intensity ratio I_{(18°-20°)}/I_{(43°-46°)} greater than or equal to 0.05 and less than or equal to 0.90, a transition metal anion octahedral three-dimensional network is formed. The three-dimensional network functions as a pillar when a large amount of Li is removed. Consequently, the crystal structure can be stably maintained. Thus, the positive electrode active material containing the lithium composite oxide (B) can intercalate and deintercalate a larger amount of Li. The positive electrode active material containing the lithium composite oxide (B) is suitable for high-capacity batteries. For the same reason, the positive electrode active material containing the lithium composite oxide (B) is also considered to be suitable for batteries with good cycle characteristics.

The crystal structure belonging to the space group Fd-3m can more easily maintain the layered structure than a layered structure belonging to the space group R-3m when a large amount of Li is removed, and is less likely to collapse.

Japanese Unexamined Patent Application Publication No. 2013-156163 discloses a positive electrode material containing a lithium composite oxide that has a crystal structure belonging to the space group Fd-3m and that includes insufficient cation mixing between lithium ions and transition metal cations. A lithium composite oxide disclosed in Japanese Unexamined Patent Application Publication No. 2013-156163 has an integrated intensity ratio I_{(18°-20°)}/I_{(43°-46°)} approximately greater than or equal to 2 and less than or equal to 3. According to Japanese Unexamined Patent Application Publication No. 2013-156163, an integrated intensity ratio I_{(18°-20°)}/I_{(43°-46°)} greater than or equal to 2 and less than or equal to 3 results in very little disorder in the crystal structure and improved characteristics of the battery.

The related art, such as Japanese Unexamined Patent Application Publication No. 2013-156163, does not disclose or suggest the lithium composite oxide (B) with an integrated intensity ratio I_{(18°-20°)}/I_{(43°-46°)} greater than or equal to 0.05 and less than or equal to 0.90.

The lithium composite oxide (B) has the crystal structure belonging to the space group Fd-3m and has an integrated intensity ratio I_{(18°-20°)}/I_{(43°-46°)} greater than or equal to 0.05 and less than or equal to 0.90. This can further improve the capacity of the battery.

To further improve the capacity of the battery, the lithium composite oxide (B) may have an integrated intensity ratio I_{(18°-20°)}/I_{(43°-46°)} greater than or equal to 0.05 and less than or equal to 0.70.

To further improve the capacity of the battery, the lithium composite oxide (B) may have an integrated intensity ratio I_{(18°-20°)}/I_{(43°-46°)} greater than or equal to 0.05 and less than or equal to 0.30.

In the lithium composite oxide (B), at least one element selected from the group consisting of F, Cl, N, and S is an optional component. In other words, the lithium composite oxide (B) does not necessarily contain at least one element selected from the group consisting of F, Cl, N, and S. The lithium composite oxide (B) can be defined as described below.

A lithium composite oxide, where

the lithium composite oxide has a crystal structure belonging to a space group Fd-3m,

the lithium composite oxide contains at least one element selected from the group consisting of Bi, La, Ce, Ga, Sr, Y, and Sn, and

the lithium composite oxide has an integrated intensity ratio I_{(18°-20°)}/I_{(43°-46 °)} greater than or equal to 0.05 and less than or equal to 0.90.

To further improve the capacity of the battery, the following four mathematical formulas may be satisfied:

1.05≤x≤1.4,

0.6≤y≤0.95,

1.33≤α≤2, and

0≤β≤0.67.

An x value greater than or equal to 1.05 results in an increased amount of Li to be intercalated into and deintercalated from the positive electrode active material. This improves the capacity.

At an x valueless than or equal to 1.4, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

At a y value greater than or equal to 0.6, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

A y valueless than or equal to 0.95 results in an increased amount of Li to be intercalated into and deintercalated from the positive electrode active material. This improves the capacity.

An α value greater than or equal to 1.33 results in the prevention of a decrease in the amount of charge compensation due to oxidation-reduction of oxygen. This improves the capacity.

An α value less than or equal to 2.0 results in the prevention of excess capacity due to oxidation-reduction of oxygen and results in stabilization of the crystal structure when Li is deintercalated. This improves the capacity.

A β valueless than or equal to 0.67 results in the prevention of an increase in the electrochemically inactive effects of Q and improved electronic conductivity. This improves the capacity.

In the lithium composite oxide (B), the mole ratio of Mn to Me may be greater than or equal to 50%. In other words, the mole ratio of Mn to Me including Mn (that is, the Mn/Me mole ratio) may be greater than or equal to 0.5 and less than or equal to 1.0.

At a Mn/Me mole ratio greater than or equal to 0.5 and less than or equal to 1.0, sufficient Mn that can easily form a hybrid orbital with oxygen suppresses oxygen desorption while charging. A relatively high degree of cation mixing (for example, an integrated intensity ratio I_{(18°-20°)}/I_{(43°-46°)} greater than or equal to 0.05 and less than or equal to 0.90) can also further stabilize the crystal structure and further improve the capacity of the battery.

The mole ratio of Mn to Me may be greater than or equal to 75%. In other words, the mole ratio of Mn to Me including Mn (that is, the Mn/Me mole ratio) may be greater than or equal to 0.75 and less than or equal to 1.0.

A Mn/Me mole ratio greater than or equal to 0.75 and less than or equal to 1.0, sufficient Mn that can easily form a hybrid orbital with oxygen suppresses oxygen desorption while charging. A relatively high degree of cation mixing (for example, an integrated intensity ratio I_{(18°-20°)}/I_{(43°-46 °)} greater than or equal to 0.05 and less than or equal to 0.90) can also further stabilize the crystal structure and further improve the capacity of the battery.

Me may contain at least one element selected from the group consisting of B, Si, P, and Al such that the mole ratio of the at least one element to Me is less than or equal to 20%.

B, Si, P, and Al, which have high covalency, stabilize the crystal structure of the lithium composite oxide. Thus, they improve cycle characteristics and extend the life of the battery.

To further improve the capacity of the battery, the following two mathematical formulas may be satisfied:

1.1≤x≤1.2 and

y=0.8.

To further improve the capacity of the battery, the following two mathematical formulas may be satisfied:

1.67≤α≤2 and

0≤β≤0.33.

To further improve the capacity of the battery, the following two mathematical formulas may be satisfied:

1.67≤α≤2 and

0<β≤0.33.

To further improve the capacity of the battery, the following two mathematical formulas may be satisfied:

1.67≤α≤1.9 and

0.1≤β≤0.33.

The mole ratio of Li to (A+Me) is represented by the mathematical formula (x/y).

To further improve the capacity of the battery, the mole ratio (x/y) may be greater than or equal to 1.3 and less than or equal to 1.9.

A mole ratio (x/y) greater than 1 results in, for example, a ratio of the number of Li atoms in the lithium composite oxide in the positive electrode active material according to the first embodiment higher than the ratio of the number of Li atoms in a known positive electrode active material represented by the composition formula LiMnO₂. This enables a larger amount of Li to be intercalated and deintercalated.

A mole ratio (x/y) greater than or equal to 1.3 results in an increased amount of available Li and therefore the formation of appropriate Li diffusion paths.

Thus, a mole ratio (x/y) greater than or equal to 1.3 results in a further improved capacity of the battery.

A mole ratio (x/y) less than or equal to 1.9 can result in the prevention of less oxidation-reduction reaction of available Me. This obviates the need to increase the utilization of an oxidation-reduction reaction of oxygen. This suppresses a decrease in the Li intercalation efficiency while discharging caused by destabilization of the crystal structure due to the deintercalation of Li while charging. This further improves the capacity of the battery.

To further improve the capacity of the battery, the mole ratio (x/y) may be greater than or equal to 1.38 and less than or equal to 1.5.

The mole ratio of O to Q is represented by the mathematical formula (α/β).

To further improve the capacity of the battery, the mole ratio (α/β) may be greater than or equal to 5 and less than or equal to 19.

A mole ratio (α/β) greater than or equal to 5 results in the prevention of a decrease in the amount of charge compensation due to oxidation-reduction of oxygen. This can also reduce the effects of electrochemically inactive Q and improves electronic conductivity. This further improves the capacity of the battery.

A mole ratio (α/β) less than or equal to 19 results in the prevention of excess capacity due to oxidation-reduction of oxygen. This stabilizes the crystal structure when Li is deintercalated. Due to the effects of electrochemically inactive Q, this also stabilizes the crystal structure when Li is deintercalated. Thus, the battery can have a higher capacity.

As described above, the lithium composite oxide may have an average composition represented by the composition formula Liₓ(A_{z}Me_{1-z})_{y}O_{α}Q_{β}. Thus, the lithium composite oxide is composed of a cation moiety and an anion moiety. The cation moiety is composed of Li, A, and Me. The anion moiety is composed of O and Q. The mole ratio of the cation moiety composed of Li, A, and Me to the anion moiety composed of O and Q is represented by the mathematical formula ((x+y)/(α+β)).

To further improve the capacity of the battery, the mole ratio ((x+y)/(α+β)) may be greater than or equal to 0.75 and less than or equal to 1.2.

A mole ratio ((x+y)/(α+β)) greater than or equal to 0.75 can result in the prevention of large amounts of impurities produced during the synthesis of the lithium composite oxide and a further improved capacity of the battery.

A mole ratio ((x+y)/(α+β)) less than or equal to 1.2 results in a decreased loss of the anion moiety of the lithium composite oxide and a stably maintained crystal structure even after lithium is deintercalated from the lithium composite oxide by charging.

To further improve the capacity and cycle characteristics of the battery, the mole ratio ((x+y)/(α+β)) may be greater than or equal to 0.95 and less than or equal to 1.0.

A mole ratio ((x+y)/(α+β)) less than or equal to 1.0 results in a cation deficiency in the crystal structure and increased Li diffusion paths. This improves the capacity of the battery. Due to randomly arranged cation deficiencies in the initial state, the crystal structure does not become unstable when Li is deintercalated. This results in a long-life battery with good cycle characteristics.

### <Lithium Composite Oxide (C)>

The lithium composite oxide (C) is described below. The lithium composite oxide (C) is a multiphase mixture that has a first phase with a crystal structure belonging to the space group Fm-3m and a second phase with a crystal structure belonging to a space group other than the space group Fm-3m.

The crystal structure belonging to the space group Fm-3m is a disordered rock-salt structure in which lithium ions and transition metal cations are randomly arranged. Thus, a larger amount of Li can be intercalated in the crystal structure belonging to the space group Fm-3m than in the common material LiCoO₂. In the crystal structure belonging to the space group Fm-3m, however, Li ions can diffuse only through adjacent Li ions or vacancies and have low diffusivity.

On the other hand, a crystal structure belonging to a space group other than the space group Fm-3m (for example, the space group Fd-3m, the space group R-3m, or the space group C2/m) has a two-dimensional Li diffusion path and has high Li diffusivity. A crystal structure belonging to a space group other than the space group Fm-3m is stable due to a strong transition metal anion octahedral network.

A combination of the first phase and the second phase in the lithium composite oxide (C) improves the capacity and life of the battery.

In the lithium composite oxide (C), a plurality of regions each formed of the first phase and a plurality of regions each formed of the second phase may be three-dimensionally randomly arranged.

The three-dimensional random arrangement increases the number of three-dimensional diffusion paths of Li, enables a larger amount of Li to be intercalated and deintercalated, and can further improve the capacity of the battery.

The lithium composite oxide (C) is a multiphase mixture. For example, a layered structure composed of a bulk layer and a coating layer covering the bulk layer is not a multiphase mixture in the present disclosure. The term “multiphase mixture”, as used herein, refers to a material with a plurality of phases. In the production of the lithium composite oxide, a plurality of materials corresponding to these phases may be mixed.

As described above, whether the lithium composite oxide is a multiphase mixture or not can be determined by X-ray diffractometry and electron diffractometry. More specifically, in a spectrum of the lithium composite oxide obtained by X-ray diffractometry and electron diffractometry, a peak with the characteristics of a plurality of phases indicates that the lithium composite oxide is a multiphase mixture.

To further improve the capacity of the battery, the second phase in the lithium composite oxide (C) may have a crystal structure belonging to at least one space group selected from the group consisting of the space group Fd-3m, the space group R-3m, and the space group C2/m.

To further improve the capacity of the battery, the second phase may have a crystal structure belonging to the space group Fd-3m.

A crystal structure belonging to the space group Fd-3m (that is, a spinel structure) has a transition metal anion octahedral three-dimensional network, which functions as a pillar. On the other hand, a crystal structure belonging to the space group R-3m or C2/m (that is, a layered structure) has a transition metal anion octahedral two-dimensional network, which functions as a pillar. Thus, when the second phase has a crystal structure belonging to the space group Fd-3m (that is, a spinel structure), the crystal structure is less likely to become unstable while charging and discharging and has a further increased discharge capacity.

In the lithium composite oxide (C), the integrated intensity ratio I_{(18°-20°)}/I_{(43°-46°)} is a parameter that can be used as a measure of the abundance ratio of the first phase to the second phase in the lithium composite oxide. An increase in the abundance ratio of the first phase probably results in a decrease in the integrated intensity ratio I_{(18°-20°)}/I_{(43°-46°)}. An increase in the abundance ratio of the second phase probably results in an increase in the integrated intensity ratio I_{(18°-20°)}/I_{(43°-46°)}.

It is thought that an integrated intensity ratio I_{(18°-20°)}/I_{(43°-46°)} less than 0.05 results in a low abundance ratio of the second phase and therefore low Li diffusivity. This results in insufficient capacity.

It is thought that an integrated intensity ratio I_{(18°-20°)}/I_{(43°-46°)} greater than 0.90 results in a decrease in the abundance ratio of the first phase and a decrease in the amounts of intercalated and deintercalated Li while charging and discharging. This results in insufficient capacity.

Thus, it is thought that the lithium composite oxide (C), which has the first phase and the second phase and has an integrated intensity ratio I_{(18°-20°)}/I_{(43°-46°)} greater than or equal to 0.05 and less than or equal to 0.90, can intercalate and deintercalate a large amount of Li, and has high Li diffusivity and a stable crystal structure. Thus, the lithium composite oxide (C) is considered to be suitable for high-capacity batteries.

To further improve the capacity of the battery, the lithium composite oxide (C) may have an integrated intensity ratio I_{(18°-20°)}/I_{(43°-46°)} greater than or equal to 0.10 and less than or equal to 0.70.

Japanese Unexamined Patent Application Publication No. 2013-156163 discloses a positive electrode material containing a lithium composite oxide that has a crystal structure belonging to the space group Fd-3m and that includes insufficient cation mixing between lithium ions and transition metal cations. A lithium composite oxide disclosed in Japanese Unexamined Patent Application Publication No. 2013-156163 has an integrated intensity ratio I_{(18°-20°)}/I_{(43°-46°)} approximately greater than or equal to 2 and less than or equal to 3. According to Japanese Unexamined Patent Application Publication No. 2013-156163, an integrated intensity ratio I_{(18°-20°)}/I_{(43°-46°)} greater than or equal to 2 and less than or equal to 3 results in very little disorder in the crystal structure and improved characteristics of the battery.

The related art, such as Japanese Unexamined Patent Application Publication No. 2013-156163, does not disclose or suggest the lithium composite oxide (C) that has the first phase and the second phase and has an integrated intensity ratio I_{(18°-20°)}/I_{(43°-46°)} greater than or equal to 0.05 and less than or equal to 0.90. The related art, such as Japanese Unexamined Patent Application Publication No. 2013-156163, does not disclose or suggest that the lithium composite oxide (C) is considered to be suitable for high-capacity batteries.

As described above, the lithium composite oxide (C) has the first phase with a crystal structure belonging to the space group Fm-3m and the second phase with a crystal structure belonging to a space group other than the space group Fm-3m (for example, the space group Fd-3m, the space group R-3m, or the space group C2/m). It is therefore not always easy to correctly identify a space group that reflects a maximum peak present in a range of angle of diffraction angle 2θ greater than or equal to 18° and less than or equal to 20°. For the same reason, it is also not always easy to correctly identify a space group that reflects a maximum peak present in a range of angle of diffraction angle 2θ greater than or equal to 43° and less than or equal to 46°. In such a case, the X-ray diffractometry may be combined with electron diffractometry using a transmission electron microscope (hereinafter referred to as “TEM”). A space group in the lithium composite oxide (C) can be identified by observing an electron diffraction pattern by a known technique. Thus, it is possible to confirm that the lithium composite oxide (C) has the first phase with a crystal structure belonging to the space group Fm-3m and the second phase with a crystal structure belonging to a space group other than the space group Fm-3m (for example, the space group Fd-3m, the space group R-3m, or the space group C2/m).

In the lithium composite oxide (C), at least one element selected from the group consisting of F, C, N, and S is an optional component. In other words, the lithium composite oxide (C) does not necessarily contain at least one element selected from the group consisting of F, Cl, N, and S. The lithium composite oxide (C) can be defined as described below.

A lithium composite oxide, where the lithium composite oxide is a multiphase mixture that has a first phase with a crystal structure belonging to the space group Fm-3m and a second phase with a crystal structure belonging to a space group other than the space group Fm-3m, the lithium composite oxide contains at least one element selected from the group consisting of Bi, La, Ce, Ga, Sr, Y, and Sn, and the integrated intensity ratio I_{(18°-20°)}/I_{(43°-46°)} is greater than or equal to 0.05 and less than or equal to 0.90.

In the lithium composite oxide (C), the following four mathematical formulas may be satisfied:

1.05≤x≤1.4,

0.6≤y≤0.95,

1.33≤α≤2, and

0≤β≤0.67.

An x value greater than or equal to 1.05 results in an increased amount of Li to be intercalated into and deintercalated from the positive electrode active material. This improves the capacity.

At an x value less than or equal to 1.4, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

At a y value greater than or equal to 0.6, an oxidation-reduction reaction of Me increases the amount of Li to be intercalated into and deintercalated from the positive electrode active material. This obviates the need to increase the utilization of an oxidation-reduction reaction of oxygen. This stabilizes the crystal structure. This improves the capacity.

A y value less than or equal to 0.95 results in an increased amount of Li to be intercalated into and deintercalated from the positive electrode active material. This improves the capacity.

An α value greater than or equal to 1.2 results in the prevention of a decrease in the amount of charge compensation due to oxidation-reduction of oxygen. This improves the capacity.

An α value less than or equal to 2.0 results in the prevention of excess capacity due to oxidation-reduction of oxygen and results in stabilization of the crystal structure when Li is deintercalated. This improves the capacity.

A β value less than or equal to 0.67 results in the prevention of an increase in the electrochemically inactive effects of Q and improved electronic conductivity. This improves the capacity.

In the lithium composite oxide (C), the mole ratio of Mn to Me may be greater than or equal to 50%. In other words, the mole ratio of Mn to Me including Mn (that is, the Mn/Me mole ratio) may be greater than or equal to 0.5 and less than or equal to 1.0.

At a Mn/Me mole ratio greater than or equal to 0.5 and less than or equal to 1.0, sufficient Mn that can easily form a hybrid orbital with oxygen suppresses oxygen desorption while charging. This can further stabilize the crystal structure with the first phase and the second phase and further improve the capacity of the battery.

The mole ratio of Mn to Me may be greater than or equal to 67.5%. In other words, the mole ratio of Mn to Me including Mn (that is, the Mn/Me mole ratio) may be greater than or equal to 0.675 and less than or equal to 1.0.

At a Mn/Me mole ratio greater than or equal to 0.675 and less than or equal to 1.0, sufficient Mn that can easily form a hybrid orbital with oxygen suppresses oxygen desorption while charging. This can further stabilize the crystal structure with the first phase and the second phase and further improve the capacity of the battery.

Me may contain at least one element selected from the group consisting of B, Si, P, and Al such that the mole ratio of the at least one element to Me is less than or equal to 20%.

B, Si, P, and Al, which have high covalency, stabilize the crystal structure of the lithium composite oxide. Thus, they improve cycle characteristics and extend the life of the battery.

To further improve the capacity of the battery, the following two mathematical formulas may be satisfied:

1.1≤x≤1.25, and

0.75≤y≤0.8.

To further improve the capacity of the battery, the following two mathematical formulas may be satisfied:

1.33≤α≤1.9, and

0.1≤β≤0.67.

The following two mathematical formulas may be satisfied:

1.33≤α≤1.67, and

0.33≤β≤0.67.

When the two mathematical formulas are satisfied, excess capacity due to oxidation-reduction of oxygen can be prevented. Furthermore, due to the sufficient effects of electrochemically inactive Q, the crystal structure can be stably maintained even when Li is deintercalated. This can further improve the capacity of the battery.

The mole ratio of Li to (A+Me) is represented by the mathematical formula (x/y).

To further improve the capacity of the battery, the mole ratio (x/y) may be greater than or equal to 1.3 and less than or equal to 1.9.

A mole ratio (x/y) greater than 1 results in, for example, a ratio of the number of Li atoms in the lithium composite oxide in the positive electrode active material according to the first embodiment higher than the ratio of the number of Li atoms in a known positive electrode active material represented by the composition formula LiMnO₂. This enables a larger amount of Li to be intercalated and deintercalated.

A mole ratio (x/y) greater than or equal to 1.3 results in an increased amount of available Li and therefore the formation of appropriate Li diffusion paths. Thus, a mole ratio (x/y) greater than or equal to 1.4 results in a further improved capacity of the battery.

A mole ratio (x/y) less than or equal to 1.9 can result in the prevention of less oxidation-reduction reaction of available Me. This obviates the need to increase the utilization of an oxidation-reduction reaction of oxygen. This suppresses a decrease in the Li intercalation efficiency while discharging caused by destabilization of the crystal structure due to the deintercalation of Li while charging. This further improves the capacity of the battery.

To further improve the capacity of the battery, the mole ratio (x/y) may be greater than or equal to 1.38 and less than or equal to 1.67.

To further improve the capacity of the battery, the mole ratio (x/y) may be greater than or equal to 1.38 and less than or equal to 1.5.

The mole ratio of O to Q is represented by the mathematical formula (a/P).

To further improve the capacity of the battery, the mole ratio (α/β) may be greater than or equal to 2 and less than or equal to 19.

A mole ratio (α/β) greater than or equal to 2 results in the prevention of a decrease in the amount of charge compensation due to oxidation-reduction of oxygen. This can also reduce the effects of electrochemically inactive Q and improves electronic conductivity. This further improves the capacity of the battery.

A mole ratio (ad) less than or equal to 19 results in the prevention of excess capacity due to oxidation-reduction of oxygen. This stabilizes the crystal structure when Li is deintercalated. Due to the effects of electrochemically inactive Q, this also stabilizes the crystal structure when Li is deintercalated. Thus, the battery can have a higher capacity.

To further improve the capacity of the battery, the mole ratio (d) may be greater than or equal to 2 and less than or equal to 5.

As described above, the lithium composite oxide may have an average composition represented by the composition formula Liₓ(A_{z}Me_{1-z})_{y}O_{α}Q_{β}. Thus, the lithium composite oxide is composed of a cation moiety and an anion moiety. The cation moiety is composed of Li, A, and Me. The anion moiety is composed of O and Q. The mole ratio of the cation moiety composed of Li, A, and Me to the anion moiety composed of O and Q is represented by the mathematical formula ((x+y)/(α+β)).

To further improve the capacity of the battery, the mole ratio ((x+y)/(α+β)) may be greater than or equal to 0.75 and less than or equal to 1.2.

A mole ratio ((x+y)/(α+β)) greater than or equal to 0.75 can result in the prevention of large amounts of impurities produced during the synthesis of the lithium composite oxide and a further improved capacity of the battery.

A mole ratio ((x+y)/(a+D)) less than or equal to 1.2 results in a decreased loss of the anion moiety of the lithium composite oxide and a stably maintained crystal structure even after lithium is deintercalated from the lithium composite oxide by charging. This further improves the capacity of the battery.

To further improve the capacity and cycle characteristics of the battery, the mole ratio ((x+y)/(α+β)) may be greater than or equal to 0.95 and less than or equal to 1.0.

A mole ratio ((x+y)/(α+β)) less than or equal to 1.0 results in a cation deficiency in the crystal structure and increased Li diffusion paths. This improves the capacity of the battery. Due to randomly arranged cation deficiencies in the initial state, the crystal structure does not become unstable when Li is deintercalated. This results in a long-life battery with good cycle characteristics.

### <Method for Producing Lithium Composite Oxide>

A method for producing a lithium composite oxide contained in the positive electrode active material according to the first embodiment is described below.

The lithium composite oxide is produced by the following method, for example.

A raw material containing Li, a raw material containing Me, and a raw material containing Q are prepared.

Examples of the raw material containing Li include lithium oxides, such as Li₂O and Li₂O₂, lithium salts, such as LiF, Li₂CO₃, and LiOH, and lithium composite oxides, such as LiMeO₂ and LiMe₂O₄.

Examples of the raw material containing Me include metal oxides, such as Me₂O₃, metal salts, such as MeCO₃ and Me(NO₃)₂, metal hydroxides, such as Me(OH)₂ and MeOOH, and lithium composite oxides, such as LiMeO₂ and LiMe₂O₄.

For example, when Me is Mn, the raw material containing Mn may be a manganese oxide, such as MnO₂ or Mn₂O₃, a manganese salt, such as MnCO₃ or Mn(NO₃)₂, a manganese hydroxide, such as Mn(OH)₂ or MnOOH, or a lithium manganese composite oxide, such as LiMnO₂ or LiMn₂O₄.

Examples of the raw material containing Q include lithium halides, transition metal halides, transition metal sulfides, and transition metal nitrides.

When Q is F, the raw material containing F may be LiF or a transition metal fluoride.

Examples of the raw material containing A include oxides of A (for example, A₂O₃), hydroxides of A, hydrates of A, nitrides of A, and sulfides of A.

For example, when A is Bi, the raw material containing Bi may be Bi₂O₃, Bi₂O₅, Bi(OH)₃, Bi₂O₃.2H₂O, Bi(NO₃)₃.5H₂O, or Bi₂(SO₄)₃.

These raw materials are weighed at the mole ratio of the composition formula (I), for example.

The x, y, z, α, and β values can be changed in this manner in the ranges described for the composition formula (I).

The raw materials are then mixed, for example, by a dry or wet process, and are then allowed to react mechanochemically for 10 hours or more in a mixer, such as a planetary ball mill, to prepare a precursor.

The precursor is heat-treated. The lithium composite oxide in the first embodiment is thus produced.

The conditions for the heat treatment are appropriately determined to produce a desired lithium composite oxide. Although the optimum heat treatment conditions depend on other production conditions and the target composition, the present inventors have found that the integrated intensity ratio I_{(18°-20°)}/I_{(43°-46°)} tends to increase with the heat treatment temperature or the heat treatment time, for example. More specifically, the present inventors have found that the degree of cation mixing tends to decrease with increasing heat treatment temperature or heat treatment time, for example. The manufacturer can determine the heat treatment conditions on the basis of this tendency. The heat treatment temperature and time may range from 300° C. to 800° C. and 30 minutes to 8 hours, for example. The heat treatment atmosphere may be an air atmosphere, an oxygen atmosphere, or an inert atmosphere (for example, a nitrogen atmosphere or an argon atmosphere).

Thus, the raw materials, the conditions for mixing the raw materials, and the heat-treatment conditions can be adjusted to produce a desired lithium composite oxide.

The space group of the crystal structure of the lithium composite oxide can be determined, for example, by X-ray diffractometry or electron diffractometry.

The average composition of the lithium composite oxide can be determined, for example, by inductively coupled plasma spectroscopy, an inert gas fusion-infrared absorption method, ion chromatography, or a combination thereof.

A lithium transition metal composite oxide can be used as a raw material to decrease the energy for mixing elements. This can increase the purity of the lithium composite oxide.

Thus, a method for producing the lithium composite oxide in the first embodiment includes (a) preparing the raw materials, (b) mechanochemically reacting the raw materials to produce a precursor of the lithium composite oxide, and (c) heat-treating the precursor to produce the lithium composite oxide.

In the step (a), a mixture may be prepared by mixing the raw materials such that the ratio of Li, Me, Q, and A is the ratio in a desired lithium composite oxide.

A lithium compound used as a raw material may be produced by a known method.

In the step (b), the mechanochemical reaction may be performed in a ball mill.

Thus, to produce the lithium composite oxide in the first embodiment, the raw materials (for example, LiF, Li₂, a transition metal oxide, or a lithium composite oxide) may be mixed in a planetary ball mill by a mechanochemical reaction to prepare a precursor, and the precursor may be heat-treated.

### Second Embodiment

A second embodiment is described below. The items described in the first embodiment can be omitted as appropriate.

A battery according to the second embodiment includes a positive electrode containing the positive electrode active material according to the first embodiment, a negative electrode, and an electrolyte.

The battery according to the second embodiment has a high capacity.

In the battery according to the second embodiment, the positive electrode may have a positive electrode active material layer. The positive electrode active material layer may contain the positive electrode active material according to the first embodiment as a main component. In other words, the mass ratio of the positive electrode active material to the positive electrode active material layer is greater than or equal to 50%.

Such a positive electrode active material layer further improve the capacity of the battery.

The mass ratio may be greater than or equal to 70%.

Such a positive electrode active material layer further improve the capacity of the battery.

The mass ratio may be greater than or equal to 90%.

Such a positive electrode active material layer further improve the capacity of the battery.

The battery according to the second embodiment may be a lithium-ion secondary battery, a non-aqueous electrolyte secondary battery, or an all-solid-state battery.

In the battery according to the second embodiment, the negative electrode may contain a negative-electrode active material that can adsorb and desorb lithium ions. The negative electrode may contain a material, where lithium metal in the material is dissolved in the electrolyte while discharging and is precipitated on the material while charging.

In the battery according to the second embodiment, the electrolyte may be a non-aqueous electrolyte (for example, a non-aqueous electrolyte solution).

In the battery according to the second embodiment, the electrolyte may be a solid electrolyte.

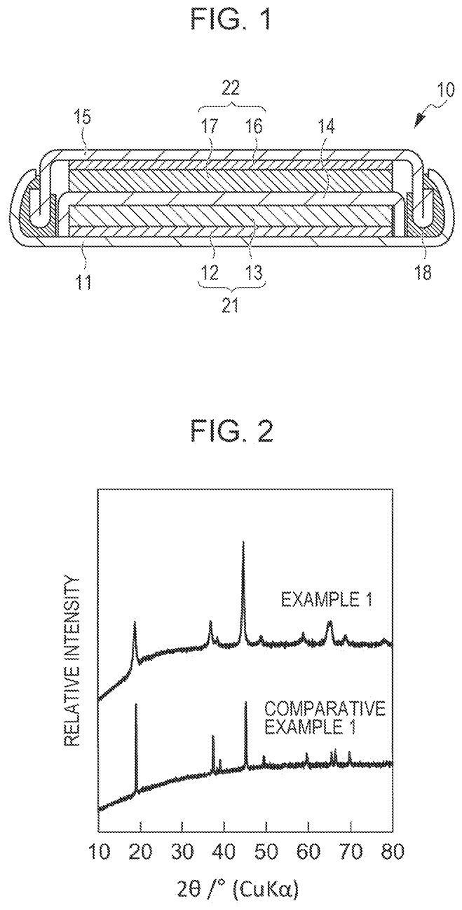

FIG. 1 is a cross-sectional view of a battery 10 according to the second embodiment.

As illustrated in FIG. 1, the battery 10 includes a positive electrode 21, a negative electrode 22, a separator 14, a case 11, a sealing plate 15, and a gasket 18.

The separator 14 is located between the positive electrode 21 and the negative electrode 22.

The positive electrode 21, the negative electrode 22, and the separator 14 are impregnated with a non-aqueous electrolyte (for example, a non-aqueous electrolyte solution), for example.

The positive electrode 21, the negative electrode 22, and the separator 14 constitute an electrode assembly.

The electrode assembly is housed in the case 11.

The case 11 is sealed with the gasket 18 and the sealing plate 15.

The positive electrode 21 includes a positive electrode current collector 12 and a positive electrode active material layer 13 located on the positive electrode current collector 12.

The positive electrode current collector 12 is made of a metallic material (for example, at least one selected from the group consisting of aluminum, stainless steel, nickel, iron, titanium, copper, palladium, gold, and platinum) or an alloy thereof, for example.

The positive electrode current collector 12 may be omitted. In such a case, the case 11 is used as a positive electrode current collector.

The positive electrode active material layer 13 contains the positive electrode active material according to the first embodiment.

If necessary, the positive electrode active material layer 13 may contain an additive agent (an electrically conductive agent, an ionic conduction aid, or a binder).

The negative electrode 22 includes a negative-electrode current collector 16 and a negative-electrode active material layer 17 located on the negative-electrode current collector 16.

The negative-electrode current collector 16 is made of a metallic material (for example, at least one selected from the group consisting of aluminum, stainless steel, nickel, iron, titanium, copper, palladium, gold, and platinum) or an alloy thereof, for example.

The negative-electrode current collector 16 may be omitted. In such a case, the sealing plate 15 is used as a negative-electrode current collector.

The negative-electrode active material layer 17 contains a negative-electrode active material.

If necessary, the negative-electrode active material layer 17 may contain an additive agent (an electrically conductive agent, an ionic conduction aid, or a binder).

The negative-electrode active material may be a metallic material, a carbon material, an oxide, a nitride, a tin compound, or a silicon compound.

The metallic material may be a single metal. Alternatively, the metallic material may be an alloy. Examples of the metallic material include lithium metal and lithium alloys.

Examples of the carbon material include natural graphite, coke, carbon during graphitization, carbon fiber, spherical carbon, artificial graphite, and amorphous carbon.

From the perspective of capacity density, the negative-electrode active material may be silicon (Si), tin (Sn), a silicon compound, or a tin compound. The silicon compound and the tin compound may be an alloy or a solid solution.

Examples of the silicon compound include SiOₓ (where 0.05<x<1.95). A compound produced by substituting part of silicon atoms of SiOₓ with another element may also be used. This compound is an alloy or a solid solution. The other element may be at least one element selected from the group consisting of boron, magnesium, nickel, titanium, molybdenum, cobalt, calcium, chromium, copper, iron, manganese, niobium, tantalum, vanadium, tungsten, zinc, carbon, nitrogen, and tin.

Examples of the tin compound include Ni₂Sn₄, Mg₂Sn, SnOₓ (where 0<x<2), SnO₂, and SnSiO₃. A tin compound selected from these compounds may be used alone. Alternatively, two or more tin compounds selected from these compounds may be used in combination.

The negative-electrode active material may have any shape. The negative-electrode active material may have a known shape (for example, particulate or fibrous).

The negative-electrode active material layer 17 may be filled with (that is, adsorb) lithium by any method. More specifically, the method may be (a) a method of depositing lithium on the negative-electrode active material layer 17 by a gas phase method, such as a vacuum evaporation method or (b) a method of heating a lithium metal foil in contact with the negative-electrode active material layer 17. In these methods, lithium is diffused into the negative-electrode active material layer 17 by heat. Lithium may also be electrochemically adsorbed on the negative-electrode active material layer 17. More specifically, a battery is produced from the negative electrode 22 free of lithium and a lithium metal foil (negative electrode). Subsequently, the battery is charged to adsorb lithium on the negative electrode 22.

Examples of the binder for the positive electrode 21 and the negative electrode 22 include poly(vinylidene difluoride), polytetrafluoroethylene, polyethylene, polypropylene, aramid resin, polyamide, polyimide, polyamideimide, polyacrylonitrile, poly(acrylic acid), poly(methyl acrylate), poly(ethyl acrylate), poly(hexyl acrylate), poly(methacrylic acid), poly(methyl methacrylate), poly(ethyl methacrylate), poly(hexyl methacrylate), poly(vinyl acetate), polyvinylpyrrolidone, polyether, polyethersulfone, hexafluoropolypropylene, styrene-butadiene rubber, and carboxymethylcellulose.

Other examples of the binder include copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more binders selected from these materials may also be used.

Examples of the electrically conductive agent for the positive electrode 21 and the negative electrode 22 include graphite, carbon black, electrically conductive fiber, graphite fluoride, metal powders, electrically conductive whiskers, electrically conductive metal oxides, and electrically conductive organic materials.

Examples of the graphite include natural graphite and artificial graphite.

Examples of the carbon black include acetylene black, Ketjen black, channel black, furnace black, lampblack, and thermal black.

Examples of the metal powders include aluminum powders.

Examples of the electrically conductive whiskers include zinc oxide whiskers and potassium titanate whiskers.

Examples of the electrically conductive metal oxides include titanium oxide.

Examples of the electrically conductive organic materials include phenylene derivatives.

An electrically conductive agent may be used to cover at least part of the surface of the binder. For example, the surface of the binder may be covered with carbon black. This can improve the capacity of the battery.

The material of the separator 14 has high ion permeability and sufficient mechanical strength. The material of the separator 14 may be a microporous thin film, woven fabric, or nonwoven fabric. More specifically, it is desirable that the separator 14 be formed of a polyolefin, such as polypropylene or polyethylene. The separator 14 formed of a polyolefin has not only good durability but also a shutdown function in case of excessive heating. The separator 14 has a thickness in the range of 10 to 300 μm (or 10 to 40 μm), for example. The separator 14 may be a monolayer film formed of one material. Alternatively, the separator 14 may be a composite film (or multilayer film) formed of two or more materials. The separator 14 has a porosity in the range of 30% to 70% (or 35% to 60%), for example. The term “porosity”, as used herein, refers to the volume ratio of pores to the separator 14. The porosity is measured by a mercury intrusion method, for example.

The non-aqueous electrolyte solution contains a non-aqueous solvent and a lithium salt dissolved in the non-aqueous solvent.

Examples of the non-aqueous solvent include cyclic carbonate solvents, chain carbonate solvents, cyclic ether solvents, chain ether solvents, cyclic ester solvents, chain ester solvents, and fluorinated solvents.

Examples of the cyclic carbonate solvents include ethylene carbonate, propylene carbonate, and butylene carbonate.

Examples of the chain carbonate solvents include dimethyl carbonate, ethyl methyl carbonate, and diethyl carbonate.

Examples of the cyclic ether solvents include tetrahydrofuran, 1,4-dioxane, and 1,3-dioxolane.

Examples of the chain ether solvents include 1,2-dimethoxyethane and 1,2-diethoxyethane.

Examples of the cyclic ester solvents include y-butyrolactone.

Examples of the chain ester solvents include methyl acetate.

Examples of the fluorinated solvents include fluoroethylene carbonate, methyl fluoropropionate, fluorobenzene, fluoroethyl methyl carbonate, and fluorodimethylene carbonate.

One non-aqueous solvent selected from these may be used alone. A combination of two or more non-aqueous solvents selected from these may also be used.

The non-aqueous electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

At least one of these fluorinated solvents in the non-aqueous electrolyte solution improves the oxidation resistance of the non-aqueous electrolyte solution.

Consequently, even when the battery 10 is charged at high voltage, the battery 10 can operate stably.

In the battery according to the second embodiment, the electrolyte may be a solid electrolyte.

Examples of the solid electrolyte include organic polymer solid electrolytes, oxide solid electrolytes, and sulfide solid electrolytes.

Examples of the organic polymer solid electrolytes include compounds of a polymer and a lithium salt. Examples of the compounds include lithium poly(styrene sulfonate).

The polymer may have an ethylene oxide structure. A polymer with an ethylene oxide structure can contain a large amount of lithium salt. This can further increase ionic conductivity.

Examples of the oxide solid electrolytes include

(i) NASICON solid electrolytes, such as LiTi₂(PO₄)₃ and substitution products thereof,

(ii) perovskite solid electrolytes, such as (LaLi)TiO₃,

(iii) LISICON solid electrolytes, such as Li₁₄ZnGe₄O₁₆, Li₄SiO₄, LiGeO₄, and substitution products thereof,

(iv) garnet solid electrolytes, such as Li₇La₃Zr₂O₁₂ and substitution products thereof,
(v) Li₃N and H-substitution products thereof, and
(vi) Li₃PO₄ and N-substitution products thereof.

Examples of the sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX (X denotes F, Cl, Br, or I), MO_{y}, or LiₓMO_{y} (M denotes P, Si, Ge, B, Al, Ga, or In; x and y independently denote a natural number) may be added to the sulfide solid electrolytes.

Among these, the sulfide solid electrolytes have high formability and high ionic conductivity. Thus, a sulfide solid electrolyte can be used as a solid electrolyte to further improve the energy density of the battery.

Among the sulfide solid electrolytes, Li₂S—P₂S₅ has high electrochemical stability and high ionic conductivity. Thus, Li₂S—P₂S₅ can be used as a solid electrolyte to further improve the energy density of the battery.

A solid electrolyte layer containing a solid electrolyte may contain the above non-aqueous electrolyte solution.

The non-aqueous electrolyte solution in the solid electrolyte layer facilitates lithium ion transfer between an active material and the solid electrolyte. This can further improve the energy density of the battery.

The solid electrolyte layer may be a gel electrolyte or ionic liquid.

Examples of the gel electrolyte include polymer materials impregnated with a non-aqueous electrolyte solution. Examples of the polymer materials include poly(ethylene oxide), polyacrylonitrile, poly(vinylidene difluoride), and poly(methyl methacrylate). Other examples of the polymer materials include polymers with an ethylene oxide bond.

Examples of cations in the ionic liquid include

(i) aliphatic chain quaternary ammonium salt cations, such as tetraalkylammonium,

(ii) aliphatic chain quaternary phosphonium salt cations, such as tetraalkylphosphonium,

(iii) alicyclic ammoniums, such as pyrrolidinium, morpholinium, imidazolinium, tetrahydropyrimidinium, piperazinium, or piperidinium, and

(iv) nitrogen-containing heteroaromatic cations, such as pyridinium and imidazolium.

An anion in the ionic liquid is PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, or C(SO₂CF₃)₃⁻. The ionic liquid may contain a lithium salt.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. A lithium salt selected from these may be used alone. A mixture of two or more lithium salts selected from these may also be used. The concentration of the lithium salt ranges from 0.5 to 2 mol/l, for example.

With respect to the shape of the battery according to the second embodiment, the battery is a coin battery, a cylindrical battery, a rectangular battery, a sheet battery, a button battery (that is, a button cell), a flat battery, or a laminated battery.

### EXAMPLES

### Example 1

### [Production of Positive Electrode Active Material]

A mixture of LiF, Li₂MnO₃, LiMnO₂, LiCoO₂, LiNiO₂, and Bi₂O₃ was prepared such that the Li/Mn/Co/Ni/O/F/Bi mole ratio was 1.2/0.4725/0.11375/0.11375/1.9/0.1/0.1.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was heat-treated at 700° C. for 1 hour in an air atmosphere. A positive electrode active material according to Example 1 was thus prepared.

The positive electrode active material according to Example 1 was subjected to powder X-ray diffractometry.

FIG. 2 shows the results of the powder X-ray diffractometry.

The positive electrode active material according to Example 1 was also subjected to electron diffractometry. The crystal structure of the positive electrode active material according to Example 1 was analyzed on the basis of the results of the powder X-ray diffractometry and electron diffractometry. The positive electrode active material according to Example 1 was identified as a mixture of a phase belonging to the space group C2/m and a phase belonging to the space group R-3m.

The integrated intensities of X-ray diffraction peaks were calculated from the results of the powder X-ray diffractometry measured with an X-ray diffractometer (manufactured by Rigaku Corporation) using software (trade name: PDXL) associated with the X-ray diffractometer. The positive electrode active material according to Example 1 had an integrated intensity ratio I_{(18°-20°)}/I_{(43°-46°)} of 0.50.

The average composition of the lithium composite oxide calculated from the mole ratio of the raw materials was represented by Li_{1.2}Mn_{0.4725}Co_{0.11375}Ni_{0.11375}Bi_{0.1}O_{1.9}F_{0.1}, as listed in Table 1. The average composition was equivalent to L_{1.2}(Bi_{0.125}(Mn_{0.675}Co_{0.1625}Ni_{0.1625})_{0.875})_{0.8}O_{1.9}F_{0.1} (that is, x=1.2, y=0.8, z=0.125, α=1.9, and β=0.1 in the composition formula (I)).

The lithium composite oxide was used as a positive electrode active material.

### [Production of Battery]

Next, 70 parts by mass of the positive electrode active material according to Example 1, 20 parts by mass of acetylene black, 10 parts by mass of poly(vinylidene difluoride) (hereinafter referred to as “PVDF”), and a proper amount of N-methyl-2-pyrrolidone (hereinafter referred to as “NMP”) were mixed. A positive electrode mixture slurry was thus prepared. The acetylene black functioned as an electrically conductive agent. The poly(vinylidene difluoride) functioned as a binder.

The positive electrode mixture slurry was applied to one surface of a positive electrode current collector formed of an aluminum foil 20 micrometers in thickness.

The positive electrode mixture slurry was dried and rolled to form a positive electrode sheet with a positive electrode active material layer.

A circular positive electrode 12.5 mm in diameter was punched out from the positive electrode sheet.

A circular negative electrode 14 mm in diameter was punched out from a lithium metal foil 300 micrometers in thickness.

Separately, fluoroethylene carbonate (hereinafter referred to as “FEC”), ethylene carbonate (hereinafter referred to as “EC”), and ethyl methyl carbonate (hereinafter referred to as “EMC”) were mixed at a volume ratio of 1:1:6 to prepare a non-aqueous solvent.

LiPF₆ was dissolved at a concentration of 1.0 mol/l in the non-aqueous solvent to prepare a non-aqueous electrolyte solution.

A separator was impregnated with the non-aqueous electrolyte solution. The separator was a product manufactured by Celgard, LLC. (product number 2320, 25 micrometers in thickness). This separator was a 3-layer separator composed of a polypropylene layer, a polyethylene layer, and a polypropylene layer.

A coin battery 20 mm in diameter and 3.2 mm in thickness was produced from the positive electrode, the negative electrode, and the separator in a dry box maintained at a dew point of −50° C.

### Example 2

In Example 2, a positive electrode active material was prepared in the same manner as in Example 1 except for the following item (i).

(i) The mole ratio of Li/Mn/Co/Ni/O/F/Bi was 1.2/0.50625/0.12188/0.12188/1.9/0.1/0.05.

The average composition of the lithium composite oxide calculated from the mole ratio of the raw materials was represented by Li_{1.2}Mn_{0.50625}Co_{0.12188}Ni_{0.12188}Bi_{0.05}O_{1.9}F_{0.1}, as listed in Table 1. The average composition was equivalent to Li_{1.2}(Bi_{0.625}(Mn_{0.675}Co_{0.1625}Ni_{0.1625})_{0.9875})_{0.8}O_{1.9}F_{0.1} (that is, x=1.2, y=0.8, z=0.0625, α=1.9, and β=0.1 in the composition formula (I)).

The physical properties and characteristics of the positive electrode active material according to Example 2 were measured in the same manner as in Example 1. Table 1 shows the results.

A coin battery according to Example 2 was produced from the positive electrode active material according to Example 2 in the same manner as in Example 1.

### Example 3

In Example 3, a positive electrode active material was prepared in the same manner as in Example 1 except for the following item (i).

(i) The mole ratio of Li/Mn/Co/Ni/O/F/Bi was 1.2/0.53325/0.12838/0.12838/1.9/0.1/0.01.

The average composition of the lithium composite oxide calculated from the mole ratio of the raw materials was represented by Li_{1.2}Mn_{0.53325}Co_{0.12838}Ni_{0.12838}Bi_{0.01}O_{1.9}F_{0.1}, as listed in Table 1. The average composition was equivalent to Li_{1.2}(Bi_{0.0125}(Mn_{0.675}Co_{0.01625}Ni_{0.1625})_{0.9375})_{0.8}O_{1.9}F_{0.1} (that is, x=1.2, y=0.8, z=0.0125, α=1.9, and β=0.1 in the composition formula (I)).

The physical properties and characteristics of the positive electrode active material according to Example 3 were measured in the same manner as in Example 1. Table 1 shows the results.

A coin battery according to Example 3 was produced from the positive electrode active material according to Example 3 in the same manner as in Example 1.

### Example 4

In Example 4, a positive electrode active material was prepared in the same manner as in Example 1 except for the following item (i).

(i) Bi₂O₃ was substituted with La₂O₃.

The average composition of the lithium composite oxide calculated from the mole ratio of the raw materials was represented by Li_{1.2}Mn_{0.4725}Co_{0.11375}Ni_{0.11375}La_{0.1}O_{1.9}F_{0.1}, as listed in Table 1. The average composition was equivalent to Li_{1.2}(La_{0.125}(Mn_{0.675}Co_{0.1625}Ni_{0.1625})_{0.875})_{0.8}O_{1.9}F_{0.1} (that is, x=1.2, y=0.8, z=0.125, α=1.9, and β=0.1 in the composition formula (I)).

The physical properties and characteristics of the positive electrode active material according to Example 4 were measured in the same manner as in Example 1. Table 1 shows the results.

A coin battery according to Example 4 was produced from the positive electrode active material according to Example 4 in the same manner as in Example 1.

### Example 5

In Example 5, a positive electrode active material was prepared in the same manner as in Example 1 except for the following items (i) and (ii).

(i) Bi₂O₃ was substituted with La₂O₃.

(ii) The mole ratio of L/Mn/Co/Ni/O/F/La was 1.2/0.50625/0.12188/0.12188/1.9/0.1/0.05.

The average composition of the lithium composite oxide calculated from the mole ratio of the raw materials was represented by Li_{1.2}Mn_{0.50625}Co_{0.12188}Ni_{0.12188}La_{0.05}O_{1.9}F_{0.1}, as listed in Table 1. The average composition was equivalent to Li_{1.2}(La_{0.0625}(Mn_{0.675}Co_{0.1625}Ni_{0.1625})_{0.9875})_{0.8}O_{1.9}F_{0.1} (that is, x=1.2, y=0.8, z=0.0625, α=1.9, and β=0.1 in the composition formula (I)).

The physical properties and characteristics of the positive electrode active material according to Example 5 were measured in the same manner as in Example 1. Table 1 shows the results.

A coin battery according to Example 5 was produced from the positive electrode active material according to Example 5 in the same manner as in Example 1.

### Example 6

In Example 6, a positive electrode active material was prepared in the same manner as in Example 1 except for the following items (i) and (ii).

(i) Bi₂O₃ was substituted with La₂O₃.

(ii) The mole ratio of Li/Mn/Co/Ni/O/F/La was 1.2/0.53325/0.12838/0.12838/1.9/0.1/0.01.

The average composition of the lithium composite oxide calculated from the mole ratio of the raw materials was represented by Li_{1.2}Mn_{0.53325}Co_{0.12838}Ni_{0.12838}La_{0.01}O_{1.9}F_{0.1}, as listed in Table 1. The average composition was equivalent to Li_{1.2}(La_{0.0125}(Mn_{0.675}Co_{0.1625}Ni_{0.1625})_{0.9375})_{0.8}O_{1.9}F_{0.1} (that is, x=1.2, y=0.8, z=0.0125, α=1.9, and β=0.1 in the composition formula (I)).

The physical properties and characteristics of the positive electrode active material according to Example 6 were measured in the same manner as in Example 1. Table 1 shows the results.

A coin battery according to Example 6 was produced from the positive electrode active material according to Example 6 in the same manner as in Example 1.

### Example 7

In Example 7, a positive electrode active material was prepared in the same manner as in Example 1 except for the following items (i) and (ii).

(i) Bi₂O₃ was substituted with CeO₂.

(ii) The mole ratio of Li/Mn/Co/Ni/O/F/Ce was 1.2/0.53325/0.12838/0.12838/1.9/0.1/0.01.

The average composition of the lithium composite oxide calculated from the mole ratio of the raw materials was represented by Li_{1.2}Mn_{0.53325}Co_{0.12838}Ni_{0.12838}Ce_{0.01}O_{1.9}F_{0.1}, as listed in Table 1. The average composition was equivalent to Li_{1.2}(La_{0.0125}(Mn_{0.675}Co_{0.1825}Ni_{0.1625})_{0.9375})_{0.8}O_{1.9}F_{0.1} (that is, x=1.2, y=0.8, z=0.0125, α=1.9, and β=0.1 in the composition formula (I)).

The physical properties and characteristics of the positive electrode active material according to Example 7 were measured in the same manner as in Example 1. Table 1 shows the results.

A coin battery according to Example 7 was produced from the positive electrode active material according to Example 7 in the same manner as in Example 1.

### Comparative Example 1

In Comparative Example 1, a positive electrode active material with a composition represented by the chemical formula LiCoO₂ (lithium cobalt oxide) was produced by a known method.

The physical properties and characteristics of the positive electrode active material in Comparative Example 1 were also measured in the same manner as in Example 1. Table 1 shows the results.

A coin battery in Comparative Example 1 was also produced from the positive electrode active material according to Comparative Example 1 in the same manner as in Example 1.

### <Evaluation of Battery Performance>

The battery according to Example 1 was charged at a current density of 0.5 mA/cm² to a voltage of 4.7 V.

The battery according to Example 1 was then discharged at a current density of 0.5 mA/cm² to a voltage of 2.5 V.

The battery according to Example 1 had an initial discharge capacity of 274 mAh/g.

The average operating voltage of the battery according to Example 1 in the discharge process was calculated. The average operating voltage was 3.53 V.

The battery according to Example 1 was charged again at a current density of 0.5 mA/cm² to a voltage of 4.7 V.

The battery according to Example 1 was then discharged at a current density of 0.5 mA/cm² to a voltage of 2.5 V.

The charging and discharging were repeated 10 times. The present inventors measured the initial volumetric energy density of the coin battery according to Example 1. The present inventors also measured the discharge capacity retention rate after 10 times of charging and discharging.

The initial volumetric energy density and the discharge capacity retention rate after 10 times of charging and discharging were measured in the coin batteries according to Examples 2 to 7 and Comparative Examples 1 in the same manner as described above.

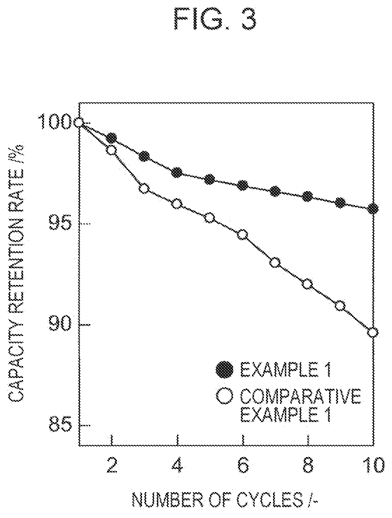

Table 1 shows the results. FIG. 3 is a graph of a change in capacity retention rate while charging and discharging of the batteries according to Example 1 and Comparative Example 1 were performed multiple times.

TABLE 1

| | | | | Energy | Capacity |
|---|---|---|---|---|---|
| | | Space | | density | retention |
| | Average composition | group | I_{(18°-20°)}/I_{(43°-46°)} | (Wh/L) | rate (%) |
| Example 1 | Li_{1.2}Mn_{0.4725}Co_{0.11375}Ni_{0.11375}Bi_{0.1}O_{1.9}F_{0.1} | R-3m | 0.50 | 4700 | 96 |
| | | C2/m | | | |
| Example 2 | Li_{1.2}Mn_{0.50625}Co_{0.12188}Ni_{0.12188}Bi_{0.05}O_{1.9}F_{0.1} | R-3m | 0.61 | 4400 | 93 |
| | | C2/m | | | |
| Example 3 | Li_{1.2}Mn_{0.53325}Co_{0.12838}Ni_{0.12838}Bi_{0.01}O_{1.9}F_{0.1} | R-3m | 0.70 | 4200 | 92 |
| | | C2/m | | | |
| Example 4 | Li_{1.2}Mn_{0.4725}Co_{0.11375}Ni_{0.11375}La_{0.1}O_{1.9}F_{0.1} | R-3m | 0.57 | 3800 | 93 |
| | | C2/m | | | |
| Example 5 | Li_{1.2}Mn_{0.50625}Co_{0.12188}Ni_{0.12188}La_{0.05}O_{1.9}F_{0.1} | R-3m | 0.58 | 3600 | 93 |
| | | C2/m | | | |
| Example 6 | Li_{1.2}Mn_{0.53325}Co_{0.12838}Ni_{0.12838}La_{0.01}O_{1.9}F_{0.1} | R-3m | 0.62 | 4100 | 90 |
| | | C2/m | | | |
| Example 7 | Li_{1.2}Mn_{0.53325}Co_{0.12838}Ni_{0.12838}Ce_{0.01}O_{1.9}F_{0.1} | R-3m | 0.79 | 4200 | 90 |
| | | C2/m | | | |
| Comparative | LiCoO₂ | R-3m | 1.20 | 3200 | 89 |
| example 1 | | | | | |

Table 1 shows that the batteries according to Examples 1 to 7 have a higher energy density and a higher capacity retention rate than the battery according to Comparative Example 1.

This is probably because the following items (i) to (iii) are satisfied in each lithium composite oxide in the positive electrode active materials according to Examples 1 to 7.

(i) The lithium composite oxide contains at least one element selected from the group consisting of F, Cl, N, and S.

(ii) The lithium composite oxide contains at least one element selected from the group consisting of Bi, La, Ce, Ga, Sr, Y, and Sn.

(iii) The lithium composite oxide has an integrated intensity ratio I_{(18°-20°)}/I_{(43°-46°)} greater than or equal to 0.05 and less than or equal to 0.90.

Such a lithium composite oxide can intercalate and deintercalate a larger amount of Li. Furthermore, the lithium composite oxide has high Li diffusivity and a stable crystal structure and has high bonding strength between metal and oxygen. Probably, this suppresses oxygen desorption while charging and discharging, and the positive electrode active material has a high true density. For these reasons, the energy density and capacity retention rate can be greatly improved.

The battery according to Example 1 has a higher energy density and a higher capacity retention rate than the batteries according to Examples 2 and 3.

This is probably because the lithium composite oxide in the positive electrode active material according to Example 1 has a higher Bi content than the lithium composite oxides in the positive electrode active materials according to Examples 2 and 3. This results in the positive electrode active material with a higher true density and improved bonding strength between oxygen and metal. For these reasons, Example 1 can have a higher energy density and a higher capacity retention rate.

The battery according to Example 1 has a higher energy density and a higher capacity retention rate than the battery according to Example 4.

This is probably because the lithium composite oxide in the positive electrode active material according to Example 4 contains La instead of Bi. Bi with a large atomic number at a transition metal site of the lithium composite oxide has increased affinity to oxygen and decreases the amount of oxygen to be gasified in the charge-discharge process. This can further suppress oxygen desorption while charging and discharging and stabilizes the crystal structure. Bi is a heavy element and therefore improves the energy density per unit volume of the positive electrode active material. The battery according to Example 1 has a higher energy density and a higher capacity retention rate than the battery according to Example 4.

The battery according to Example 1 has a higher energy density and a higher capacity retention rate than the batteries according to Examples 5 to 7.

This is probably because the Bi content of the lithium composite oxide in the positive electrode active material according to Example 1 is higher than the La or Ce content of each lithium composite oxide in the positive electrode active materials according to Examples 5 to 7. This results in the positive electrode active material with a higher true density and improved bonding strength between oxygen and metal. For these reasons, Example 1 can have a higher energy density and a higher capacity retention rate.

Reference examples are described below. In the reference examples, the lithium composite oxide in the positive electrode active material does not contain any of the elements Bi, La, Ce, Ga, Sr, Y, and Sn.

### Reference Example 1-1

In Reference Example 1-1, a mixture of LiF, Li₂MnO₃, LiMnO₂, LiCoO₂, and LiNiO₂ was prepared such that the L/Mn/Co/Ni/O/F mole ratio was 1.2/0.54/0.13/0.13/1.9/0.1.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was subjected to X-ray powder diffractometry.

The space group of the precursor was identified as Fm-3m.

The precursor was heat-treated at 700° C. for 1 hour in an air atmosphere. A positive electrode active material according to Reference Example 1-1 was thus prepared.

The positive electrode active material according to Reference Example 1-1 was subjected to powder X-ray diffractometry.

The space group of the positive electrode active material according to Reference Example 1-1 was identified as C2/m.

The positive electrode active material according to Reference Example 1-1 had an integrated intensity ratio I_{(18°-20°)}/I_{(43°-46°)} of 0.80.

The positive electrode active material according to Reference Example 1-1 was used to produce a coin battery according to Reference Example 1-1 in the same manner as in Example 1.

### Reference Examples 1-2 to 1-26

In Reference Examples 1-2 to 1-26, a positive electrode active material was prepared in the same manner as in Reference Example 1-1 except for the following items (i) and (ii).

(i) The mixing ratio of the mixture (that is, the mixing ratio of L/Me/O/F) was changed. See Table 2 for details.

(ii) The heating conditions were changed in the range of 600° C. to 900° C. and in the range of 30 minutes to 1 hour.

The space group of the positive electrode active materials according to Reference Examples 1-2 to 1-26 was identified as C2/m.

In Reference Examples 1-2 to 1-26, a precursor was prepared in the same manner as in Reference Example 1-1 from the raw materials mixed at the stoichiometric ratio.

For example, in Reference Example 1-13, a mixture of LiF, Li₂MnO₃, LiCoO₂, LiNiO₂, and MgO was used such that the L/Mn/Co/Ni/Mg/O/F mole ratio was 1.2/0.49/0.13/0.13/0.05/1.9/0.1.

The positive electrode active materials according to Reference Examples 1-2 to 1-26 were used to produce coin batteries according to Reference Examples 1-2 to 1-26 in the same manner as in Reference Example 1-1.

### Reference Example 1-27

In Reference Example 1-27, a positive electrode active material with a composition represented by Li_{1.2}Mn_{0.54}Co_{0.13}Ni_{0.13}O_{1.9}F_{0.1} was prepared in the same manner as in Reference Example 1-1.

In Reference Example 1-27, a precursor was heat-treated at 700° C. for 3 hours. The positive electrode active material according to Reference Example 1-27 was thus prepared.

The positive electrode active material according to Reference Example 1-27 was subjected to powder X-ray diffractometry.

The space group of the positive electrode active material according to Reference Example 1-27 was identified as C2/m.

The positive electrode active material according to Reference Example 1-27 had an integrated intensity ratio I_{(18°-20°)}/I_{(43°-46°)} of 1.03.

The positive electrode active material according to Reference Example 1-27 was used to produce a coin battery according to Reference Example 1-27 in the same manner as in Reference Example 1-1.

### Reference Example 1-28

In Reference Example 1-28, a positive electrode active material with a composition represented by Li_{1.2}Mn_{0.54}Co_{0.13}Ni_{0.13}O_{1.9}F_{0.1} was prepared in the same manner as in Reference Example 1-1.

In Reference Example 1-28, a precursor was heat-treated at 300° C. for 10 minutes. The positive electrode active material according to Reference Example 1-28 was thus prepared.

The positive electrode active material according to Reference Example 1-28 was subjected to powder X-ray diffractometry.

The space group of the positive electrode active material according to Reference Example 1-28 was identified as C2/m.

The positive electrode active material according to Reference Example 1-28 had an integrated intensity ratio I_{(18°-20°)}/I_{(43°-46°)} of 0.02.

The positive electrode active material according to Reference Example 1-28 was used to produce a coin battery according to Reference Example 1-28 in the same manner as in Reference Example 1-1.

### Reference Example 1-29

In Reference Example 1-29, a positive electrode active material with a composition represented by Li_{1.2}Mn_{0.54}Co_{0.13}Ni_{0.13}O_{2.0} was prepared in the same manner as in Reference Example 1-1.

LiF was not used in Reference Example 1-29.

The positive electrode active material according to Reference Example 1-29 was subjected to powder X-ray diffractometry.

The space group of the positive electrode active material according to Reference Example 1-29 was identified as C2/m.

The positive electrode active material according to Reference Example 1-29 had an integrated intensity ratio I_{(18°-20°)}/I_{(43°-46°)} of 0.82.

The positive electrode active material according to Reference Example 1-29 was used to produce a coin battery according to Reference Example 1-29 in the same manner as in Reference Example 1-1.

### Reference Example 1-30

In Reference Example 1-30, a positive electrode active material with a composition represented by Li_{1.2}Mn_{0.54}Co_{0.13}Ni_{0.13}O_{1.9}F_{0.1} was prepared in the same manner as in Reference Example 1-1.

In Reference Example 1-30, no heat treatment was performed.

The positive electrode active material according to Reference Example 1-30 was subjected to powder X-ray diffractometry.

The space group of the positive electrode active material according to Reference Example 1-30 was identified as Fm-3m.

The positive electrode active material according to Reference Example 1-30 was used to produce a coin battery according to Reference Example 1-30 in the same manner as in Reference Example 1-1.

### Reference Example 1-31

In Reference Example 1-31, a positive electrode active material with a composition represented by LiCoO₂ was produced by a known method.

The positive electrode active material was subjected to X-ray powder diffractometry.

The space group of the positive electrode active material according to Reference Example 1-31 was identified as R-3m.

The positive electrode active material according to Reference Example 1-31 was used to produce a coin battery according to Reference Example 1-31 in the same manner as in Reference Example 1-1.

### <Evaluation of Battery Performance>

The battery according to Reference Example 1-1 was charged at a current density of 0.5 mA/cm² to a voltage of 4.9 V.

The battery according to Reference Example 1-1 was then discharged at a current density of 0.5 mA/cm² to a voltage of 2.5 V.

The battery according to Reference Example 1-1 had an initial discharge capacity of 299 mAh/g.

The battery according to Reference Example 1-27 was charged at a current density of 0.5 mA/cm² to a voltage of 4.3 V.

The battery according to Reference Example 1-27 was then discharged at a current density of 0.5 mA/cm² to a voltage of 2.5 V.

The battery according to Reference Example 1-27 had an initial discharge capacity of 236 mAh/g.

The initial discharge capacities of the coin batteries according to Reference Examples 1-2 to 1-26, 1-28, and 1-31 were measured.

Table 2 shows the results.

TABLE 2A

| | Average composition | x/y | α/β |
|---|---|---|---|
| Reference | Li_{1.2}Mn_{0.54}Co_{0.13}Ni_{0.13}O_{1.9}F_{0.1} | 1.5 | 19 |
| example 1-1 | | | |
| Reference | Li_{1.2}Mn_{0.54}Co_{0.13}Ni_{0.13}O_{1.9}F_{0.1} | 1.5 | 19 |
| example 1-2 | | | |
| Reference | Li_{1.2}Mn_{0.54}Co_{0.13}Ni_{0.13}O_{1.9}F_{0.1} | 1.5 | 19 |
| example 1-3 | | | |
| Reference | Li_{1.2}Mn_{0.54}Co_{0.13}Ni_{0.13}O_{1.9}F_{0.1} | 1.5 | 19 |
| example 1-4 | | | |
| Reference | Li_{1.2}Mn_{0.54}Co_{0.13}Ni_{0.13}O_{1.95}F_{0.05} | 1.5 | 39 |
| example 1-5 | | | |
| Reference | Li_{1.2}Mn_{0.54}Co_{0.13}Ni_{0.13}O_{1.8}F_{0.2} | 1.5 | 9 |
| example 1-6 | | | |
| Reference | Li_{1.2}Mn_{0.54}O_{1.9}F_{0.1} | 1.5 | 19 |
| example 1-7 | | | |
| Reference | Li_{1.2}Mn_{0.6}Co_{0.2}O_{1.9}F_{0.1} | 1.5 | 19 |
| example 1-8 | | | |
| Reference | Li_{1.2}Mn_{0.6}Ni_{0.2}O_{1.9}F_{0.1} | 1.5 | 19 |
| example 1-9 | | | |
| Reference | Li_{1.25}Mn_{0.51}Co_{0.12}O_{1.9}F_{0.1} | 1.7 | 19 |
| example 1-10 | | | |
| Reference | Li_{1.3}Mn_{0.5}Co_{0.1}Ni_{0.1}O_{1.9}F_{0.1} | 1.9 | 19 |
| example 1-11 | | | |
| Reference | Li_{1.5}Mn_{0.57}Co_{0.14}Ni_{0.14}O_{1.9}F_{0.1} | 1.3 | 19 |
| example 1-12 | | | |
| Reference | Li_{1.2}Mn_{0.49}Co_{0.13}Ni_{0.13}Mg_{0.05}O_{1.9}F_{0.1} | 1.5 | 19 |
| example 1-13 | | | |
| Reference | Li_{1.25}Mn_{0.49}Co_{0.13}Ni_{0.13}B_{0.05}O_{1.9}F_{0.1} | 1.5 | 19 |
| example 1-14 | | | |
| Reference | Li_{1.2}Mn_{0.49}Co_{0.13}Ni_{0.13}P_{0.05}O_{1.9}F_{0.1} | 1.5 | 19 |
| example 1-15 | | | |
| Reference | Li_{1.2}Mn_{0.49}Co_{0.13}Ni_{0.13}Al_{0.05}O_{1.9}F_{0.1} | 1.5 | 19 |
| example 1-16 | | | |
| Reference | Li_{1.2}Mn_{0.49}Co_{0.13}Ni_{0.13}Ti_{0.05}O_{1.9}F_{0.1} | 1.5 | 19 |
| example 1-17 | | | |
| Reference | Li_{1.2}Mn_{0.49}Co_{0.13}Ni_{0.13}Nb_{0.05}O_{1.9}F_{0.1} | 1.5 | 19 |
| example 1-18 | | | |
| Reference | Li_{1.2}Mn_{0.49}Co_{0.13}Ni_{0.13}W_{0.05}O_{1.9}F_{0.1} | 1.5 | 19 |
| example 1-19 | | | |
| Reference | Li_{1.2}Mn_{0.49}Co_{0.13}Ni_{0.13}V_{0.05}O_{1.9}F_{0.1} | 1.5 | 19 |
| example 1-20 | | | |
| Reference | Li_{1.2}Mn_{0.49}Co_{0.13}Ni_{0.13}Cr_{0.05}O_{1.9}F_{0.1} | 1.5 | 19 |
| example 1-21 | | | |
| Reference | Li_{1.2}Mn_{0.49}Co_{0.13}Ni_{0.13}Si_{0.05}O_{1.9}F_{0.1} | 1.5 | 19 |
| example 1-22 | | | |
| Reference | Li_{1.2}Mn_{0.49}Co_{0.13}Ni_{0.13}Fe_{0.05}O_{1.9}F_{0.1} | 1.5 | 19 |
| example 1-23 | | | |
| Reference | Li_{1.2}Mn_{0.49}Co_{0.13}Ni_{0.13}Cu_{0.05}O_{1.9}F_{0.1} | 1.5 | 19 |
| example 1-24 | | | |
| Reference | Li_{1.2}Mn_{0.49}Co_{0.13}Ni_{0.13}Ru_{0.05}O_{1.9}F_{0.1} | 1.5 | 19 |
| example 1-25 | | | |

TABLE 2B

| | Average composition | x/y | α/β |
|---|---|---|---|
| Reference | Li_{1.2}Mn_{0.49}Co_{0.13}Ni_{0.13}Na_{0.05}O_{1.9}F_{0.1} | 1.5 | 19 |
| example 1-26 | | | |
| Reference | Li_{1.2}Mn_{0.54}Co_{0.13}Ni_{0.13}O_{1.9}F_{0.1} | 1.5 | 19 |
| example 1-27 | | | |
| Reference | Li_{1.2}Mn_{0.54}Co_{0.13}Ni_{0.13}O_{1.9}F_{0.1} | 1.5 | 19 |
| example 1-28 | | | |
| Reference | Li_{1.2}Mn_{0.54}Co_{0.13}Ni_{0.13}O₂ | 1.5 | — |
| example 1-29 | | | |
| Reference | Li_{1.2}Mn_{0.54}Co_{0.13}Ni_{0.13}O_{1.9}F_{0.1} | 1.5 | 19 |
| example 1-30 | | | |
| Reference | LiCoO₂ | 1.0 | — |
| example 1-31 | | | |

TABLE 2C

| | | | I_{(18°-} | Initial |
|---|---|---|---|---|
| | | | _{20°)}/ | discharge |
| | (x + y)/ | Space | I_{(43°-} | capacity |
| | (α + β) | group | _{46°)} | (mAh/g) |
| Reference | 1.0 | C2/m | 0.80 | 299 |
| example 1-1 | | | | |
| Reference | 1.0 | C2/m | 0.62 | 289 |
| example 1-2 | | | | |
| Reference | 1.0 | C2/m | 0.11 | 282 |
| example 1-3 | | | | |
| Reference | 1.0 | C2/m | 0.85 | 274 |
| example 1-4 | | | | |
| Reference | 1.0 | C2/m | 0.78 | 294 |
| example 1-5 | | | | |
| Reference | 1.0 | C2/m | 0.83 | 269 |
| example 1-6 | | | | |
| Reference | 1.0 | C2/m | 0.65 | 281 |
| example 1-7 | | | | |
| Reference | 1.0 | C2/m | 0.44 | 276 |
| example 1-8 | | | | |
| Reference | 1.0 | C2/m | 0.69 | 274 |
| example 1-9 | | | | |
| Reference | 1.0 | C2/m | 0.70 | 271 |
| example 1-10 | | | | |
| Reference | 1.0 | C2/m | 0.53 | 266 |
| example 1-11 | | | | |
| Reference | 1.0 | C2/m | 0.61 | 269 |
| example 1-12 | | | | |
| Reference | 1.0 | C2/m | 0.79 | 295 |
| example 1-13 | | | | |
| Reference | 1.0 | C2/m | 0.77 | 298 |
| example 1-14 | | | | |
| Reference | 1.0 | C2/m | 0.79 | 292 |
| example 1-15 | | | | |
| Reference | 1.0 | C2/m | 0.80 | 290 |
| example 1-16 | | | | |
| Reference | 1.0 | C2/m | 0.80 | 285 |
| example 1-17 | | | | |
| Reference | 1.0 | C2/m | 0.76 | 283 |
| example 1-18 | | | | |
| Reference | 1.0 | C2/m | 0.74 | 283 |
| example 1-19 | | | | |
| Reference | 1.0 | C2/m | 0.81 | 291 |
| example 1-20 | | | | |
| Reference | 1.0 | C2/m | 0.80 | 294 |
| example 1-21 | | | | |
| Reference | 1.0 | C2/m | 0.82 | 286 |
| example 1-22 | | | | |
| Reference | 1.0 | C2/m | 0.75 | 285 |
| example 1-23 | | | | |

TABLE 2D

| | | | I_{(18°-} | Initial |
|---|---|---|---|---|
| | | | _{20°)}/ | discharge |
| | (x + y)/ | Space | I_{(43°-} | capacity |
| | (α + β) | group | _{46°)} | (mAh/g) |
| Reference | 1.0 | C2/m | 0.77 | 288 |
| example 1-24 | | | | |
| Reference | 1.0 | C2/m | 0.76 | 285 |
| example 1-25 | | | | |
| Reference | 1.0 | C2/m | 0.77 | 285 |
| example 1-26 | | | | |
| Reference | 1.0 | C2/m | 1.03 | 236 |
| example 1-27 | | | | |
| Reference | 1.0 | C2/m | 0.02 | 256 |
| example 1-28 | | | | |
| Reference | 1.0 | C2/m | 0.82 | 249 |
| example 1-29 | | | | |
| Reference | 1.0 | Fm-3m | — | 253 |
| example 1-30 | | | | |
| Reference | 1.0 | R-3m | — | 89 |
| example 1-31 | | | | |

Table 2 shows that the batteries according to Reference Examples 1-1 to 1-26 have an initial discharge capacity in the range of 266 to 299 mAh/g.

The batteries according to Reference Examples 1-1 to 1-26 have a higher initial discharge capacity than the batteries according to Reference Examples 1-27 to 1-31.

This is probably because the following items (i) to (iii) are satisfied in the batteries according to Reference Examples 1-1 to 1-26.

(i) In Reference Examples 1-1 to 1-26, the lithium composite oxide in the positive electrode active material contains F.

(ii) The lithium composite oxide has a crystal structure belonging to the space group C2/m.

(iii) In Reference Examples 1-1 to 1-26, the lithium composite oxide has an integrated intensity ratio I_{(18°-20°)}/I_{(43°-46°)} greater than or equal to 0.05 and less than or equal to 0.90.

It is thought that the substitution of electronegative F for part of oxygen stabilized the crystal structure. Furthermore, an integrated intensity ratio I_{(18°-20°)}/I_{(43°-46°)} greater than or equal to 0.05 and less than or equal to 0.90 probably resulted in satisfactory cation mixing between Li and Me, thus resulting in an increased amount of adjacent Li and improved Li diffusivity. These effects could work together to greatly increase the initial discharge capacity.

In Reference Example 1-27, an integrated intensity ratio I_{(18°-20°)}/I_{(43°-46°)} greater than 0.90 probably resulted in suppressed cation mixing and a decreased number of three-dimensional diffusion paths of lithium. This probably hindered the diffusion of lithium and decreased the initial discharge capacity.

In Reference Example 1-28, an integrated intensity ratio I_{(18°-20°)}/I_{(43°-46°)} less than 0.05 probably resulted in a thermodynamically unstable crystal structure and caused the crystal structure to collapse due to the deintercalation of Li while charging. This probably decreased the initial discharge capacity.

In Reference Example 1-29, it is thought that the absence of F in the lithium composite oxide made the crystal structure unstable and caused the crystal structure to collapse due to the deintercalation of Li while charging. This probably decreased the initial discharge capacity.

Table 2 shows that the battery according to Reference Example 1-2 has a lower initial discharge capacity than the battery according to Reference Example 1-1.

This is probably because the integrated intensity ratio I_{(18°-20°)}/I_{(43°-46°)} is lower in Reference Example 1-2 than in Reference Example 1-1. This probably made the crystal structure unstable and decreased the initial discharge capacity.

Table 2 shows that the battery according to Reference Example 1-3 has a lower initial discharge capacity than the battery according to Reference Example 1-1.

This is probably because the integrated intensity ratio I_{(18°-20°)}/I_{(43°-46°)} is lower in Reference Example 1-3 than in Reference Example 1-2. This probably made the crystal structure unstable and decreased the initial discharge capacity.

Table 2 shows that the battery according to Reference Example 1-4 has a lower initial discharge capacity than the battery according to Reference Example 1-1.

This is probably because the integrated intensity ratio I_{(18°-20°)}/I_{(43°-46°)} is higher in Reference Example 1-4 than in Reference Example 1-2. This probably suppressed cation mixing and slightly decreased three-dimensional diffusion paths of lithium. This probably decreased the initial discharge capacity.

Table 2 shows that the battery according to Reference Example 1-5 has a lower initial discharge capacity than the battery according to Reference Example 1-1.

This is probably because the mole ratio (α/β) is higher in Reference Example 1-5 than in Reference Example 1-1. Thus, it is thought that the capacity becomes excessive due to oxidation-reduction of oxygen. Furthermore, it is thought that the effects of electronegative F were decreased, and the crystal structure became unstable when Li was deintercalated. This decreased the initial discharge capacity.

Table 2 shows that the battery according to Reference Example 1-6 has a lower initial discharge capacity than the battery according to Reference Example 1-1.

This is probably because the mole ratio (α/β) is lower in Reference Example 1-6 than in Reference Example 1-1. Thus, it is thought that the amount of charge compensation is decreased due to oxidation-reduction of oxygen. Furthermore, it is thought that the effects of electronegative F were increased, and the electronic conductivity was decreased. This decreased the initial discharge capacity.

Table 2 shows that the batteries according to Reference Examples 1-7 to 1-9 have a lower initial discharge capacity than the battery according to Reference Example 1-1.

This is probably because neither Co nor Ni was contained in Reference Examples 1-7 to 1-9. As described above, Co stabilizes the crystal structure. Ni promotes the deintercalation of Li. Reference Examples 1-7 to 1-9 had a lower initial discharge capacity probably because neither Co nor Ni was contained.

Table 2 shows that the battery according to Reference Example 1-10 has a lower initial discharge capacity than the battery according to Reference Example 1-1.

This is probably because the mole ratio (x/y) is higher in Reference Example 1-10 than in Reference Example 1-1. Thus, it is thought that a large amount of Li in the crystal structure was deintercalated during the initial charging of the battery, and the crystal structure became unstable. This probably decreased the amount of Li intercalated while discharging and decreased the initial discharge capacity.

Table 2 shows that the battery according to Reference Example 1-11 has a lower initial discharge capacity than the battery according to Reference Example 1-1.

This is probably because the mole ratio (x/y) is higher in Reference Example 1-11 than in Reference Example 1-10. Thus, it is thought that a large amount of Li in the crystal structure was deintercalated during the initial charging of the battery, and the crystal structure became unstable. This probably decreased the amount of Li intercalated while discharging and decreased the initial discharge capacity.

Table 2 shows that the battery according to Reference Example 1-12 has a lower initial discharge capacity than the battery according to Reference Example 1-1.

This is probably because the mole ratio (x/y) is lower in Reference Example 1-12 than in Reference Example 1-1. This probably decreased the amount of Li involved in the reaction and decreased the Li ion diffusivity. This probably decreased the initial discharge capacity.

Table 2 shows that the batteries according to Reference Examples 1-13 to 1-26 have a lower initial discharge capacity than the battery according to Reference Example 1-1.

This is probably because the Mn content is lower in Reference Examples 1-13 to 1-26 than in Reference Example 1-1. As described above, Mn easily forms a hybrid orbital with oxygen. A lower Mn content probably resulted in slightly reduced contribution to an oxidation-reduction reaction of oxygen and a decreased initial discharge capacity.

### Reference Example 2-1

### [Production of Positive Electrode Active Material]

In Reference Example 2-1, lithium manganese composite oxides (Li₂MnO₃ and LiMnO₂) and lithium cobalt oxide (LiCoO₂) were prepared by a known method. A mixture of Li₂MnO₃, LiMnO₂, LiCoO₂, and LiF was prepared at a Li₂MnO₃/LiMnO₂/LiCoO₂/LiF mole ratio of 3/1/4/1.

A 45-ml container containing the mixture and a proper number of zirconia balls 5 mm in diameter was hermetically-sealed in an argon glove box. The container was made of zirconia.

The container was taken out of the argon glove box. The mixture in the container was treated in an argon atmosphere in a planetary ball mill at 600 rpm for 35 hours to prepare a compound.

The compound was fired in the air at 700° C. for 1 hour. A positive electrode active material according to Reference Example 2-1 was thus prepared.

The positive electrode active material according to Reference Example 2-1 was subjected to powder X-ray diffractometry. FIG. 2 shows the results.

On the basis of the results of the X-ray diffractometry, the space group of the positive electrode active material according to Reference Example 2-1 was identified as R-3m.

The positive electrode active material according to Reference Example 2-1 had an integrated intensity ratio I_{(18°-20°)}/I_{(43°-46°)} of 0.75.

The composition of the positive electrode active material according to Reference Example 2-1 was determined by inductively coupled plasma spectroscopy, an inert gas fusion-infrared absorption method, and ion chromatography.

The positive electrode active material according to Reference Example 2-1 had a composition of Li_{1.2}Mn_{0.4}Co_{0.4}O_{1.9}F_{0.1}.

### [Production of Battery]

Next, 70 parts by mass of the positive electrode active material according to Example 1, 20 parts by mass of acetylene black, 10 parts by mass of poly(vinylidene difluoride) (hereinafter referred to as “PVDF”), and a proper amount of N-methyl-2-pyrrolidone (hereinafter referred to as “NMP”) were mixed. A positive electrode mixture slurry was thus prepared. The acetylene black functioned as an electrically conductive agent. The poly(vinylidene difluoride) functioned as a binder.

The positive electrode mixture slurry was applied to one surface of a positive electrode current collector formed of an aluminum foil 20 micrometers in thickness.

The positive electrode mixture slurry was dried and rolled to form a positive electrode sheet with a positive electrode active material layer. The positive electrode sheet had a thickness of 60 micrometer

A circular positive electrode 12.5 mm in diameter was punched out from the positive electrode sheet.

A circular negative electrode 14 mm in diameter was punched out from a lithium metal foil 300 micrometers in thickness.

Separately, fluoroethylene carbonate (hereinafter referred to as “FEC”), ethylene carbonate (hereinafter referred to as “EC”), and ethyl methyl carbonate (hereinafter referred to as “EMC”) were mixed at a volume ratio of 1:1:6 to prepare a non-aqueous solvent.

LiPF₆ was dissolved at a concentration of 1.0 mol/I in the non-aqueous solvent to prepare a non-aqueous electrolyte solution.

A separator was impregnated with the non-aqueous electrolyte solution. The separator was a product manufactured by Celgard, LLC. (product number 2320, 25 micrometers in thickness). This separator was a 3-layer separator composed of a polypropylene layer, a polyethylene layer, and a polypropylene layer.

A coin battery 20 mm in diameter and 3.2 mm in thickness was produced from the positive electrode, the negative electrode, and the separator in a dry box maintained at a dew point of −50° C.

### Reference Examples 2-2 to 2-19

In Reference Examples 2-2 to 2-19, a positive electrode active material was prepared in the same manner as in Reference Example 2-1 except for the following items (i) and (ii).

(i) The mixing ratio of the mixture (that is, the mixing ratio of Li/Me/O/F) was changed. See Table 3 for details.

(ii) The firing conditions were changed in the range of 300° C. to 700° C. and in the range of 1 to 5 hours.

In Reference Examples 2-2 to 2-19, a precursor was prepared in the same manner as in Reference Example 2-1 from the raw materials mixed at the stoichiometric ratio.

For example, in Reference Example 2-9, a mixture of Li₂MnO₃, LiMnO₂, LiNiO₂, and LiF was used at a Li₂MnO₃/LiMnO₂/LiNiO₂/LiF mole ratio of 3/1/4/1.

The space group of the positive electrode active materials according to Reference Examples 2-2 to 2-19 was identified as R-3m.

The positive electrode active materials according to Reference Examples 2-2 to 2-19 were used to produce coin batteries according to Reference Examples 2-2 to 2-19 in the same manner as in Reference Example 2-1.

### Reference Example 2-20

In Reference Example 2-20, lithium cobalt oxide (LiCoO₂) was produced by a known method.

A positive electrode active material according to Reference Example 2-20 was subjected to powder X-ray diffractometry.

The space group of the positive electrode active material according to Reference Example 2-20 was identified as R-3m.

The positive electrode active material according to Reference Example 2-20 had an integrated intensity ratio I_{(18°-20°)}/I_{(43°-46°)} of 1.20.

The positive electrode active material according to Reference Example 2-20 was used to produce a coin battery according to Reference Example 2-20 in the same manner as in Reference Example 2-1.

### Reference Example 2-21

### [Production of Positive Electrode Active Material]

In Reference Example 2-21, a mixture of Li₂MnO₃, LiMnO₂, LiCoO₂, and LiF was prepared at a Li₂MnO₃/LiMnO₂/LiCoO₂/LiF mole ratio of 3/1/4/1.

A 45-ml container containing the mixture and a proper number of zirconia balls 5 mm in diameter was hermetically-sealed in an argon glove box. The container was made of zirconia.

The container was taken out of the argon glove box. The mixture in the container was treated in an argon atmosphere in a planetary ball mill at 600 rpm for 35 hours to prepare a compound.

The compound was fired in the air at 800° C. for 1 hour. A positive electrode active material according to Reference Example 2-21 was thus prepared.

The positive electrode active material according to Reference Example 2-21 was subjected to powder X-ray diffractometry.

On the basis of the results of the X-ray diffractometry, the space group of the positive electrode active material according to Reference Example 2-21 was identified as R-3m.

The positive electrode active material according to Reference Example 2-21 had an integrated intensity ratio I_{(18°-20°)}/I_{(43°-46°)} of 0.92.

The composition of the positive electrode active material according to Reference Example 2-21 was determined by inductively coupled plasma spectroscopy, an inert gas fusion-infrared absorption method, and ion chromatography.

The positive electrode active material according to Reference Example 2-21 had a composition of Li_{1.2}Mn_{0.4}Co_{0.4}O_{1.9}F_{0.1}.

The positive electrode active material according to Reference Example 2-21 was used to produce a coin battery according to Reference Example 2-21 in the same manner as in Reference Example 2-1.

### Reference Example 2-22

### [Production of Positive Electrode Active Material]

In Reference Example 2-22, a mixture of Li₂MnO₃ and LiCoO₂ at a Li₂MnO₃/LiCoO₂ mole ratio of 1/1 was prepared.

A 45-ml container containing the mixture and a proper number of zirconia balls 5 mm in diameter was hermetically-sealed in an argon glove box. The container was made of zirconia.

The container was taken out of the argon glove box. The mixture in the container was treated in an argon atmosphere in a planetary ball mill at 600 rpm for 35 hours to prepare a compound.

The compound was fired in the air at 700° C. for 1 hour. A positive electrode active material according to Reference Example 2-22 was thus prepared.

The positive electrode active material according to Reference Example 2-22 was subjected to powder X-ray diffractometry.

On the basis of the results of the X-ray diffractometry, the space group of the positive electrode active material according to Reference Example 2-22 was identified as R-3m.

The positive electrode active material according to Reference Example 2-22 had an integrated intensity ratio I_{(18°-20°)}/I_{(43°-46°)} of 0.75.

The composition of the positive electrode active material according to Reference Example 2-22 was determined by inductively coupled plasma spectroscopy, an inert gas fusion-infrared absorption method, and ion chromatography.

The positive electrode active material according to Reference Example 2-22 had a composition of Li_{1.2}Mn_{0.4}Co_{0.4}O₂.

The positive electrode active material according to Reference Example 2-22 was used to produce a coin battery according to Reference Example 2-22 in the same manner as in Reference Example 2-1.

### <Evaluation of Battery Performance>

The battery according to Reference Example 2-1 was charged at a current density of 0.5 mA/cm² to a voltage of 4.5 V.

The battery according to Reference Example 2-1 was then discharged at a current density of 0.5 mA/cm² to a voltage of 2.5 V.

The battery according to Reference Example 2-1 had an initial energy density of 4000 Wh/L.

The battery according to Reference Example 2-20 was charged at a current density of 0.5 mA/cm² to a voltage of 4.3 V.

The battery according to Reference Example 2-20 was then discharged at a current density of 0.5 mA/cm² to a voltage of 3.0 V.

The battery according to Reference Example 2-27 had an initial energy density of 2500 Wh/L.

The initial energy densities of the coin batteries according to Reference Examples 2-2 to 2-19, 2-21, and 2-22 were measured.

Table 3 shows the results.

TABLE 3

| | | | | | | | Energy |
|---|---|---|---|---|---|---|---|
| | | | | | \|_{(18°-20°}/₎\| | Space | density |
| | Composition | x/y | α/β | (x + y)/(α + β) | _{(43°-46°)} | group | (Wh/L) |
| Reference | Li_{1.2}Mn_{0.4}Co_{0.4}O_{1.9}F_{0.1} | 1.5 | 19 | 1.0 | 0.75 | R-3m | 4000 |
| example 2-1 | | | | | | | |
| Reference | Li_{1.2}Mn_{0.4}Co_{0.4}O_{1.9}F_{0.1} | 1.5 | 19 | 1.0 | 0.69 | R-3m | 3750 |
| example 2-2 | | | | | | | |
| Reference | Li_{1.2}Mn_{0.4}Co_{0.4}O_{1.9}F_{0.1} | 1.5 | 19 | 1.0 | 0.85 | R-3m | 3710 |
| example 2-3 | | | | | | | |
| Reference | Li_{1.2}Mn_{0.35}Co_{0.45}O_{1.9}F_{0.1} | 1.5 | 19 | 1.0 | 0.77 | R-3m | 3900 |
| example 2-4 | | | | | | | |
| Reference | Li_{1.2}Mn_{0.4}Co_{0.4}O_{1.95}F_{0.05} | 1.5 | 9 | 1.0 | 0.78 | R-3m | 3800 |
| example 2-5 | | | | | | | |
| Reference | Li_{1.2}Mn_{0.4}Co_{0.4}O_{1.8}F_{0.2} | 1.5 | 9 | 1.0 | 0.79 | R-3m | 3430 |
| example 2-6 | | | | | | | |
| Reference | Li_{1.2}Mn_{0.4}Co_{0.4}O_{1.67}F_{0.33} | 1.5 | 5 | 1.0 | 0.17 | R-3m | 3160 |
| example 2-7 | | | | | | | |
| Reference | Li_{1.2}Mn_{0.8}O_{1.9}F_{0.1} | 1.5 | 19 | 1.0 | 0.67 | R-3m | 3520 |
| example 2-8 | | | | | | | |
| Reference | Li_{1.2}Mn_{0.4}Ni_{0.4}O_{1.9}F_{0.1} | 1.5 | 19 | 1.0 | 0.82 | R-3m | 3390 |
| example 2-9 | | | | | | | |
| Reference | Li_{1.2}Mn_{0.4}Co_{0.4}O_{1.95}Cl_{0.05} | 1.7 | 39 | 1.0 | 0.76 | R-3m | 3210 |
| example 2-10 | | | | | | | |
| Reference | Li_{1.2}Mn_{0.4}Co_{0.4}O_{1.95}N_{0.05} | 1.9 | 9 | 1.0 | 0.76 | R-3m | 3160 |
| example 2-11 | | | | | | | |
| Reference | Li_{1.2}Mn_{0.4}Co_{0.4}O_{1.95}S_{0.05} | 1.3 | 39 | 1.0 | 0.72 | R-3m | 3100 |
| example 2-12 | | | | | | | |
| Reference | Li_{1.2}Mn_{0.4}Co_{0.4}O_{1.95}F_{0.025}Cl_{0.025} | 1.5 | 39 | 1.0 | 0.74 | R-3m | 3200 |
| example 2-13 | | | | | | | |
| Reference | Li_{1.0}Mn_{0.5}Co_{0.5}O_{1.9}F_{0.1} | 1.0 | 19 | 1.0 | 0.72 | R-3m | 3040 |
| example 2-14 | | | | | | | |
| Reference | Li_{1.5}Mn_{0.25}Co_{0.25}O_{1.9}F_{0.1} | 3.0 | 19 | 1.0 | 0.81 | R-3m | 3080 |
| example 2-15 | | | | | | | |
| Reference | Li_{0.5}Mn_{0.5}Co_{0.5}O_{1.9}F_{0.1} | 0.5 | 19 | 0.75 | 0.62 | R-3m | 3010 |
| example 2-16 | | | | | | | |
| Reference | Li_{1.4}Mn_{0.45}Co_{0.45}O_{1.9}F_{0.1} | 1.56 | 19 | 1.15 | 0.79 | R-3m | 3560 |
| example 2-17 | | | | | | | |
| Reference | Li_{1.33}Mn_{0.33}Co_{0.34}O_{1.9}F_{0.1} | 1.99 | 9 | 1.0 | 0.79 | R-3m | 3200 |
| example 2-18 | | | | | | | |
| Reference | Li_{1.14}Mn_{0.36}Co_{0.38}O_{1.9}F_{0.1} | 1.5 | 19 | 0.95 | 0.69 | R-3m | 3150 |
| example 2-19 | | | | | | | |
| Reference | LiCoO₂ | 1.0 | — | 1.0 | 1.20 | R-3m | 2500 |
| example 2-20 | | | | | | | |
| Reference | Li_{1.2}Mn_{0.4}Co_{0.4}O_{1.9}F_{0.1} | 1.5 | 19 | 1.0 | 0.92 | R-3m | 2200 |
| example 2-21 | | | | | | | |
| Reference | Li_{1.2}Mn_{0.4}Co_{0.4}O_{2.0} | 1.5 | — | 1.0 | 0.75 | R-3m | 2900 |
| example 2-22 | | | | | | | |

As listed in Table 3, the batteries according to Reference Examples 2-1 to 2-19 have a much higher initial energy density than the batteries according to Reference Examples 2-20 to 2-22.

This is probably because the following items (i) to (iii) are satisfied in the batteries according to Reference Examples 2-1 to 2-19.

(i) In Reference Examples 2-1 to 2-19, the lithium composite oxide in the positive electrode active material contains at least one element selected from the group consisting of F, Cl, N, and S.

(ii) The lithium composite oxide has a crystal structure belonging to the space group R-3m.

(iii) In Reference Examples 2-1 to 2-19, the lithium composite oxide has an integrated intensity ratio I_{(18°-20°)}/I_{(43°-46°)} greater than or equal to 0.62 and less than or equal to 0.90.

These effects could work together to improve the energy density.

In Reference Example 2-21, an integrated intensity ratio I_{(18°-20°)}/I_{(43°-46°)} greater than 0.90 probably resulted in suppressed cation mixing and a decreased number of three-dimensional diffusion paths of lithium. This probably hindered the diffusion of lithium and decreased the energy density.

In Reference Example 2-22, which contained no electrochemically inactive anion, such as F, Cl, N, or S, the crystal structure became unstable. This probably decreased the energy density.

Table 3 shows that the battery according to Reference Example 2-2 has a lower initial energy density than the battery according to Reference Example 2-1. This is probably because the integrated intensity ratio I_{(18°-20°)}/I_{(43°-46°)} is lower in Reference Example 2-2 than in Reference Example 2-1. More specifically, the crystal structure became relatively unstable probably due to a high degree of cation mixing. This probably decreased the energy density.

Table 3 shows that the battery according to Reference Example 2-3 has a lower energy density than the battery according to Reference Example 2-1. This is probably because the integrated intensity ratio I_{(18°-20°)}/I_{(43°-46°)} is higher in Reference Example 2-3 than in Reference Example 2-1. This probably suppressed cation mixing and slightly decreased three-dimensional diffusion paths of lithium. This probably decreased the energy density.

Table 3 shows that the battery according to Reference Example 2-5 has a lower initial energy density than the battery according to Reference Example 2-1. This is probably because the mole ratio (α/β) is higher in Reference Example 2-5 than in Reference Example 2-1. Thus, it is thought that the capacity becomes excessive due to oxidation-reduction of oxygen. Furthermore, it is thought that the effects of electronegative F were decreased, and the crystal structure became unstable when Li was deintercalated. This probably decreased the energy density.

Table 3 shows that the battery according to Reference Example 2-6 has a lower initial energy density than the battery according to Reference Example 2-1. This is probably because the mole ratio (α/β) is lower in Reference Example 2-6 than in Reference Example 2-1. Thus, it is thought that the amount of charge compensation is decreased due to oxidation-reduction of oxygen. Furthermore, it is thought that the effects of electronegative F were increased, and the electronic conductivity was decreased. This probably decreased the energy density.

Table 3 shows that the battery according to Reference Example 2-7 has a lower initial energy density than the battery according to Reference Example 2-6.

This is probably because the mole ratio (α/β) is lower in Reference Example 2-7 than in Reference Example 2-6. Thus, it is thought that the amount of charge compensation is decreased due to oxidation-reduction of oxygen. Furthermore, it is thought that the effects of electronegative F were increased, and the electronic conductivity was decreased. This probably decreased the energy density.

Table 3 shows that the battery according to Reference Example 2-8 has a lower initial energy density than the battery according to Reference Example 2-1. This is probably because the only cation other than Li is Mn in Reference Example 2-8, which facilitated oxygen desorption and made the crystal structure unstable. This probably decreased the energy density.

Table 3 shows that the battery according to Reference Example 2-9 has a lower initial energy density than the battery according to Reference Example 2-1. This is probably because Ni was used instead of Co as a cation in Reference Example 2-9. The orbital overlap was smaller between oxygen and Ni than between oxygen and Co. This probably results in an insufficient capacity due to an oxidation-reduction reaction of oxygen and a decreased energy density.

Table 3 shows that the batteries according to Reference Examples 2-10 to 2-13 have a lower initial energy density than the battery according to Reference Example 2-5.

This is probably because an anion with lower electronegativity than F was used instead of F in Reference Examples 2-10 to 2-13. This probably resulted in weaker interaction between cations and anions and a decreased energy density.

Table 3 shows that the battery according to Reference Example 2-14 has a lower initial energy density than the battery according to Reference Example 2-1.

This is probably because a lower molar ratio (x/y) in Reference Example 2-14 than in Reference Example 2-1 resulted in a decrease in the number of properly secured percolation paths of Li and a decrease in Li ion diffusivity. This probably decreased the energy density.

Table 3 shows that the battery according to Reference Example 2-15 has a lower initial energy density than the battery according to Reference Example 2-1.

This is probably because the mole ratio (x/y) is higher in Reference Example 2-15 than in Reference Example 2-1. Thus, it is thought that a large amount of Li in the crystal structure was deintercalated during the initial charging of the battery, and the crystal structure became unstable. This probably decreased the amount of Li intercalated while discharging and decreased the energy density.

Table 3 shows that the battery according to Reference Example 2-16 has a lower initial energy density than the battery according to Reference Example 2-1.

This is probably because the mole ratios (x/y) and ((x+y)/(α+β)) are smaller in Reference Example 2-16 than in Reference Example 2-1. More specifically, Li deficiency during synthesis causes Mn and Co to be regularly arranged. This probably resulted in insufficient percolation paths of Li ions and a decrease in Li ion diffusivity. This probably decreased the energy density.

Table 3 shows that the battery according to Reference Example 2-17 has a lower initial energy density than the battery according to Reference Example 2-1.

This is probably because the mole ratio ((x+y)/(α+β)) is higher in Reference Example 2-17 than in Reference Example 2-1. More specifically, anion deficiencies in the initial structure facilitated oxygen desorption during charging and made the crystal structure unstable. This probably decreased the energy density.

Table 3 shows that the battery according to Reference Example 2-18 has a lower initial energy density than the battery according to Reference Example 2-1.

This is probably because the mole ratio (x/y) is higher in Reference Example 2-18 than in Reference Example 2-1. Thus, it is thought that a large amount of Li in the crystal structure was deintercalated during the initial charging of the battery, and the crystal structure became unstable. This probably decreased the amount of Li intercalated while discharging and decreased the energy density.

Table 3 shows that the battery according to Reference Example 2-19 has a lower initial energy density than the battery according to Reference Example 2-1.

This is probably because the mole ratio (x/y) is lower in Reference Example 2-19 than in Reference Example 2-1. More specifically, a slight Li deficiency during synthesis causes Mn and Co to be regularly arranged. This probably resulted in insufficient percolation paths of Li ions and a decrease in Li ion diffusivity. Furthermore, the integrated intensity ratio I_{(18°-20°)}/I_{(43°-46°)} is lower in Reference Example 2-19 than in Reference Example 2-1. In other words, excessive cation mixing in Reference Example 2-19 probably made the crystal structure relatively unstable. This probably decreased the energy density.

### Reference Example 3-1

### [Production of Positive Electrode Active Material]

In Reference Example 3-1, a mixture of LiF, Li₂MnO₃, and LiMnO₂ was prepared such that the Li/Mn/O/F mole ratio was 1.2/0.8/1.67/0.33.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was subjected to X-ray powder diffractometry.

The space group of the precursor was identified as Fm-3m.

The precursor was then heat-treated at 500° C. for 1 hour in an air atmosphere. A positive electrode active material according to Reference Example 3-1 was thus prepared.

The positive electrode active material according to Reference Example 3-1 was subjected to powder X-ray diffractometry.

The space group of the positive electrode active material according to Reference Example 3-1 was identified as Fd-3m.

The positive electrode active material according to Reference Example 3-1 had an integrated intensity ratio I_{(18°-20°)}/I_{(43°-46°)} of 0.23.

### [Production of Battery]

Next, 70 parts by mass of the positive electrode active material according to Example 1, 20 parts by mass of acetylene black, 10 parts by mass of poly(vinylidene difluoride) (hereinafter referred to as “PVDF”), and a proper amount of N-methyl-2-pyrrolidone (hereinafter referred to as “NMP”) were mixed. A positive electrode mixture slurry was thus prepared. The acetylene black functioned as an electrically conductive agent. The poly(vinylidene difluoride) functioned as a binder.

The positive electrode mixture slurry was applied to one surface of a positive electrode current collector formed of an aluminum foil 20 micrometers in thickness.

The positive electrode mixture slurry was dried and rolled to form a positive electrode sheet with a positive electrode active material layer. The positive electrode sheet had a thickness of 60 micrometer

A circular positive electrode 12.5 mm in diameter was punched out from the positive electrode sheet.

A circular negative electrode 14 mm in diameter was punched out from a lithium metal foil 300 micrometers in thickness.

Separately, fluoroethylene carbonate (hereinafter referred to as “FEC”), ethylene carbonate (hereinafter referred to as “EC”), and ethyl methyl carbonate (hereinafter referred to as “EMC”) were mixed at a volume ratio of 1:1:6 to prepare a non-aqueous solvent.

LiPF₆ was dissolved at a concentration of 1.0 mol/l in the non-aqueous solvent to prepare a non-aqueous electrolyte solution.

A separator was impregnated with the non-aqueous electrolyte solution. The separator was a product manufactured by Celgard, LLC. (product number 2320, 25 micrometers in thickness). This separator was a 3-layer separator composed of a polypropylene layer, a polyethylene layer, and a polypropylene layer.

A coin battery 20 mm in diameter and 3.2 mm in thickness was produced from the positive electrode, the negative electrode, and the separator in a dry box maintained at a dew point of −50° C.

### Reference Examples 3-2 to 3-19

In Reference Examples 3-2 to 3-19, a positive electrode active material was prepared in the same manner as in Reference Example 3-1 except for the following items (i) and (ii).

(i) The mixing ratio of the mixture (that is, the mixing ratio of Li/Me/O/F) was changed. See Table 4 for details.

(ii) The firing conditions were changed in the range of 400° C. to 600° C. and in the range of 30 minutes to 2 hours.

The space group of the positive electrode active material according to Reference Examples 3-2 to 3-19 was identified as Fd-3m.

In Reference Examples 3-2 to 3-19, a precursor was prepared in the same manner as in Reference Example 3-1 from the raw materials mixed at the stoichiometric ratio.

For example, in Reference Example 3-4, a mixture of LiF, Li₂MnO₃, LiMnO₂, LiCoO₂, and LiNiO₂ was used such that the Li/Mn/Co/Ni/O/F mole ratio was 1.2/0.6/0.1/0.1/1.67/0.33.

The positive electrode active materials according to Reference Examples 3-2 to 3-19 were used to produce coin batteries according to Reference Examples 3-2 to 3-19 in the same manner as in Reference Example 3-1.

### Reference Example 3-20

In Reference Example 3-20, a positive electrode active material with a composition represented by Li_{1.2}Mn_{0.8}O₂ was prepared in the same manner as in Reference Example 3-1.

LiF was not used in Reference Example 3-20.

The space group of the positive electrode active material according to Reference Example 3-20 was identified as Fd-3m.

The positive electrode active material according to Reference Example 3-20 had an integrated intensity ratio I_{(18°-20°)}/I_{(43°-46°)} of 0.15.

The positive electrode active material according to Reference Example 3-20 was used to produce a coin battery according to Reference Example 3-20 in the same manner as in Reference Example 3-1.

### Reference Example 3-21

In Reference Example 3-21, a positive electrode active material with a composition represented by LiMn₂O₄ was prepared by a known technique.

The positive electrode active material according to Reference Example 3-21 was subjected to powder X-ray diffractometry.

The space group of the positive electrode active material according to Reference Example 3-21 was identified as Fd-3m.

The positive electrode active material according to Reference Example 3-21 had an integrated intensity ratio I_{(18°-20°)}/I_{(43°-46°)} of 1.30.

The positive electrode active material according to Reference Example 3-21 was used to produce a coin battery according to Reference Example 3-21 in the same manner as in Reference Example 3-1.

### Reference Example 3-22

In Reference Example 3-22, a positive electrode active material with a composition represented by Li_{1.2}Mn_{0.8}O_{1.67}F_{0.33} was prepared in the same manner as in Reference Example 3-1.

In Reference Example 3-22, heat treatment was performed at 500° C. for 5 hours.

The space group of the positive electrode active material according to Reference Example 3-22 was identified as Fd-3m.

The positive electrode active material according to Reference Example 3-22 had an integrated intensity ratio I_{(18°-20°)}/I_{(43°-46°)} of 1.04.

The positive electrode active material according to Reference Example 3-22 was used to produce a coin battery according to Reference Example 3-22 in the same manner as in Reference Example 3-1.

### Reference Example 3-23

In Reference Example 3-23, a positive electrode active material with a composition represented by Li_{1.2}Mn_{0.8}O_{1.67}F_{0.33} was prepared in the same manner as in Reference Example 3-1.

In Reference Example 3-23, heat treatment was performed at 500° C. for 10 minutes.

The space group of the positive electrode active material according to Reference Example 3-23 was identified as Fd-3m.

The positive electrode active material according to Reference Example 3-23 had an integrated intensity ratio I_{(18°-20°)}/I_{(43°-46°)} of 0.02.

The positive electrode active material according to Reference Example 3-23 was used to produce a coin battery according to Reference Example 3-23 in the same manner as in Reference Example 3-1.

### <Evaluation of Battery Performance>

The battery according to Reference Example 3-1 was charged at a current density of 0.5 mA/cm² to a voltage of 4.9 V.

The battery according to Reference Example 3-1 was then discharged at a current density of 0.5 mA/cm² to a voltage of 2.5 V.

The battery according to Reference Example 3-1 had an initial discharge capacity of 300 mAh/g.

The battery according to Reference Example 3-21 was charged at a current density of 0.5 mA/cm² to a voltage of 4.3 V.

The battery according to Reference Example 3-21 was then discharged at a current density of 0.5 mA/cm² to a voltage of 2.5 V.

The battery according to Reference Example 3-21 had an initial discharge capacity of 140 mAh/g.

The initial discharge capacities of the coin batteries according to Reference Examples 3-2 to 3-20 and Reference Examples 3-22 to 3-23 were measured.

Table 4 shows the results.

TABLE 4

| | | | | | Space | \|_{(18°-20°)}/\| | Initial discharge |
|---|---|---|---|---|---|---|---|
| | Composition | x/y | α/β | (x + y)/(α + β) | group | _{(43°-46°)} | capacity (mAh/g) |
| Reference | Li_{1.2}Mn_{0.8}O_{1.67}F_{0.33} | 1.5 | 5 | 1.0 | Fd-3m | 0.23 | 300 |
| example 3-1 | | | | | | | |
| Reference | Li_{1.2}Mn_{0.8}O_{1.67}F_{0.33} | 1.5 | 5 | 1.0 | Fd-3m | 0.05 | 284 |
| example 3-2 | | | | | | | |
| Reference | Li_{1.2}Mn_{0.8}O_{1.67}F_{0.33} | 1.5 | 5 | 1.0 | Fd-3m | 0.70 | 272 |
| example 3-3 | | | | | | | |
| Reference | Li_{1.2}Mn_{0.5}Co_{0.1}Ni_{0.1}O_{1.67}F_{0.33} | 1.5 | 5 | 1.0 | Fd-3m | 0.30 | 287 |
| example 3-4 | | | | | | | |
| Reference | Li_{1.2}Mn_{0.4}Co_{0.2}Ni_{0.2}O_{1.67}F_{0.33} | 1.5 | 5 | 1.0 | Fd-3m | 0.25 | 275 |
| example 3-5 | | | | | | | |
| Reference | Li_{1.2}Mn_{0.8}O_{1.9}F_{0.33} | 1.5 | 19 | 1.0 | Fd-3m | 0.25 | 292 |
| example 3-6 | | | | | | | |
| Reference | Li_{1.1}Mn_{0.8}O_{1.67}F_{0.33} | 1.38 | 5 | 0.95 | Fd-3m | 0.29 | 297 |
| example 3-7 | | | | | | | |
| Reference | Li_{1.2}Mn_{0.75}B_{0.05}O_{1.67}F_{0.33} | 1.5 | 5 | 1.0 | Fd-3m | 0.28 | 285 |
| example 3-8 | | | | | | | |
| Reference | Li_{1.2}Mn_{0.75}P_{0.05}O_{1.67}F_{0.33} | 1.5 | 5 | 1.0 | Fd-3m | 0.24 | 289 |
| example 3-9 | | | | | | | |
| Reference | Li_{1.2}Mn_{0.75}Al_{0.05}O_{1.67}F_{0.33} | 1.5 | 5 | 1.0 | Fd-3m | 0.23 | 282 |
| example 3-10 | | | | | | | |
| Reference | Li_{1.2}Mn_{0.75}Ti_{0.05}O_{1.67}F_{0.33} | 1.5 | 5 | 1.0 | Fd-3m | 0.23 | 280 |
| example 3-11 | | | | | | | |
| Reference | Li_{1.2}Mn_{0.75}Nb_{0.05}O_{1.67}F_{0.33} | 1.5 | 5 | 1,0 | Fd-3m | 0.19 | 277 |
| example 3-12 | | | | | | | |
| Reference | Li_{1.2}Mn_{0.75}W_{0.05}O_{1.67}F_{0.33} | 1.5 | 5 | 1.0 | Fd-3m | 0.20 | 276 |
| example 3-13 | | | | | | | |
| Reference | Li_{1.2}Mn_{0.75}V_{0.05}O_{1.67}F_{0.33} | 1.5 | 5 | 1.0 | Fd-3m | 0.22 | 281 |
| example 3-14 | | | | | | | |
| Reference | Li_{1.2}Mn_{0.75}Cr_{0.05}O_{1.67}F_{0.33} | 1.5 | 5 | 1.0 | Fd-3m | 0.22 | 283 |
| example 3-15 | | | | | | | |
| Reference | Li_{1.2}Mn_{0.75}Si_{0.05}O_{1.67}F_{0.33} | 1.5 | 5 | 1.0 | Fd-3m | 0.24 | 275 |
| example 3-16 | | | | | | | |
| Reference | Li_{1.2}Mn_{0.75}Fe_{0.05}O_{1.67}F_{0.33} | 1.5 | 5 | 1.0 | Fd-3m | 0.19 | 276 |
| example 3-17 | | | | | | | |
| Reference | Li_{1.2}Mn_{0.75}Cu_{0.05}O_{1.67}F_{0.33} | 1.5 | 5 | 1.0 | Fd-3m | 0.22 | 274 |
| example 3-18 | | | | | | | |
| Reference | Li_{1.2}Mn_{0.75}Ru_{0.05}O_{1.67}F_{0.33} | 1.5 | 5 | 1.0 | Fd-3m | 0.21 | 278 |
| example 3-19 | | | | | | | |
| Reference | Li_{1.2}Mn_{0.8}O₂ | 1.5 | — | 1.0 | Fd-3m | 0.15 | 267 |
| example 3-20 | | | | | | | |
| Reference | LiMn₂O₄ | 0.5 | — | 0.75 | Fd-3m | 1.30 | 140 |
| example 3-21 | | | | | | | |
| Reference | Li_{1.2}Mn_{0.8}O_{1.67}F_{0.33} | 1.5 | 5 | 1.0 | Fd-3m | 1.04 | 238 |
| example 3-22 | | | | | | | |
| Reference | Li_{1.2}Mn_{0.8}O_{1.67}F_{0.33} | 1.5 | 5 | 1.0 | Fd-3m | 0.02 | 251 |
| example 3-23 | | | | | | | |

Table 4 shows that the batteries according to Reference Examples 3-1 to 3-20 have an initial discharge capacity in the range of 267 to 300 mAh/g.

Thus, the batteries according to Reference Examples 3-1 to 3-20 have a higher initial discharge capacity than the batteries according to Reference Examples 3-21 to 3-23.

This is probably because the following items (i) and (ii) are satisfied in the batteries according to Reference Examples 3-1 to 3-20.

(i) In Reference Examples 3-1 to 3-20, the lithium composite oxide in the positive electrode active material has a crystal structure belonging to the space group Fd-3m.

(ii) In Reference Examples 3-1 to 3-20, the lithium composite oxide has an integrated intensity ratio I_{(18°-20°)}/I_{(43°-46°)} greater than or equal to 0.05 and less than or equal to 0.90.

Satisfactory cation mixing between Li and Me increased the amount of adjacent Li and improved the Li diffusivity. This probably increased the number of three-dimensional diffusion paths of lithium and enabled a larger amount of Li to be intercalated and deintercalated. This probably greatly improved the initial discharge capacity.

In Reference Example 3-21, an integrated intensity ratio I_{(18°-20°)}/I_{(43°-46°)} greater than 0.90 probably resulted in suppressed cation mixing and a decreased number of three-dimensional diffusion paths of lithium. Furthermore, in Reference Example 3-21, a low mole ratio (x/y) probably resulted in a decreased amount of Li involved in the reaction and a decrease in Li ion diffusivity. This probably hindered the diffusion of lithium and greatly decreased the initial discharge capacity.

In Reference Example 3-22, an integrated intensity ratio I_{(18°-20°)}/I_{(43°-46°)} greater than 0.90 probably resulted in suppressed cation mixing and a decreased number of three-dimensional diffusion paths of lithium. This probably decreased the initial discharge capacity.

In Reference Example 3-23, an integrated intensity ratio I_{(18°-20°)}/I_{(43°-46°)} less than 0.05 probably resulted in a thermodynamically unstable crystal structure and caused the crystal structure to collapse due to the deintercalation of Li while charging. This probably decreased the initial discharge capacity.

Table 4 shows that the battery according to Reference Example 3-2 has a lower initial discharge capacity than the battery according to Reference Example 3-1.

This is probably because the integrated intensity ratio I_{(18°-20°)}/I_{(43°-46°)} is lower in Reference Example 3-2 than in Reference Example 3-1. This probably made the crystal structure unstable and decreased the initial discharge capacity.

Table 4 shows that the battery according to Reference Example 3-3 has a lower initial discharge capacity than the battery according to Reference Example 3-1.

This is probably because the integrated intensity ratio I_{(18°-20°)}/I_{(43°-46°)} is higher in Reference Example 3-3 than in Reference Example 3-1. This probably suppressed cation mixing and slightly decreased three-dimensional diffusion paths of lithium. This probably decreased the initial discharge capacity.

Table 4 shows that the battery according to Reference Example 3-4 has a lower initial discharge capacity than the battery according to Reference Example 3-1.

This is probably because the Mn content is smaller in Reference Example 3-4 than in Reference Example 3-1. As described above, Mn easily forms a hybrid orbital with oxygen. Co and Ni are less likely to form a hybrid orbital with oxygen than Mn. In Reference Example 3-4, it is therefore thought that oxygen desorbed while charging, and the crystal structure became unstable. In other words, it is thought that contribution to an oxidation-reduction reaction of oxygen was decreased in Reference Example 3-4. This probably decreased the initial discharge capacity.

Table 4 shows that the battery according to Reference Example 3-5 has a lower initial discharge capacity than the battery according to Reference Example 3-4.

This is probably because the Mn content is smaller in Reference Example 3-5 than in Reference Example 3-4. As described above, Mn easily forms a hybrid orbital with oxygen. A further decrease in Mn content in Reference Example 3-5 probably resulted in a further decrease in initial discharge capacity.

Table 4 shows that the battery according to Reference Example 3-6 has a lower initial discharge capacity than the battery according to Reference Example 3-1.

This is probably because the mole ratio (α/β) is higher in Reference Example 3-6 than in Reference Example 3-1. Thus, it is thought that the capacity becomes excessive due to oxidation-reduction of oxygen. Furthermore, it is thought that the effects of electronegative F were decreased, and the crystal structure became unstable when Li was deintercalated. This probably decreased the initial discharge capacity.

Table 4 shows that the battery according to Reference Example 3-7 has a lower initial discharge capacity than the battery according to Reference Example 3-1.

This is probably because the mole ratio (x/y) is lower in Reference Example 3-7 than in Reference Example 3-1. This probably increased isolated Li in the crystal structure and decreased the amount of Li involved in the reaction. This probably decreased the Li ion diffusivity and decreased the initial discharge capacity. Isolated Li, however, functioned as a pillar and improved cycle characteristics.

Table 4 shows that the batteries according to Reference Examples 3-8 to 3-19 have a smaller initial discharge capacity than the battery according to Reference Example 3-1.

This is probably because the Mn content is smaller in Reference Examples 3-8 to 3-19 than in Reference Example 3-1. As described above, Mn easily forms a hybrid orbital with oxygen. A lower Mn content probably resulted in reduced contribution to an oxidation-reduction reaction of oxygen and a decreased initial discharge capacity.

Table 4 shows that the battery according to Reference Example 3-20 has a lower initial discharge capacity than the battery according to Reference Example 3-1.

This is probably because the lithium composite oxide in Reference Example 3-20 contains no F. F has high electronegativity. In Reference Example 3-20, F does not substitute for part of oxygen, and the interaction between cations and anions is probably decreased. Consequently, it is thought that oxygen desorption while charging made the crystal structure unstable and decreased the initial discharge capacity.

### Reference Example 4-1

[Production of Positive electrode Active Material]

In Reference Example 4-1, a mixture of LiF, Li₂MnO₃, and LiMnO₂ was prepared such that the Li/MnO/F mole ratio was 1.2/0.8/1.33/0.67.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was subjected to X-ray powder diffractometry.

The space group of the precursor was identified as Fm-3m.

The precursor was then heat-treated at 500° C. for 2 hours in an air atmosphere. A positive electrode active material according to Reference Example 4-1 was thus prepared.

The positive electrode active material according to Reference Example 4-1 was subjected to powder X-ray diffractometry and electron diffractometry.

The positive electrode active material according to Reference Example 4-1 had an integrated intensity ratio I_{(18°-20°)}/I_{(43°-46°)} of 0.50.

### [Production of Battery]

Next, 70 parts by mass of the positive electrode active material according to Example 1, 20 parts by mass of acetylene black, 10 parts by mass of poly(vinylidene difluoride) (hereinafter referred to as “PVDF”), and a proper amount of N-methyl-2-pyrrolidone (hereinafter referred to as “NMP”) were mixed. A positive electrode mixture slurry was thus prepared. The acetylene black functioned as an electrically conductive agent. The poly(vinylidene difluoride) functioned as a binder.

The positive electrode mixture slurry was applied to one surface of a positive electrode current collector formed of an aluminum foil 20 micrometers in thickness.

The positive electrode mixture slurry was dried and rolled to forma positive electrode sheet with a positive electrode active material layer. The positive electrode sheet had a thickness of 60 micrometer

A circular positive electrode 12.5 mm in diameter was punched out from the positive electrode sheet.

A circular negative electrode 14 mm in diameter was punched out from a lithium metal foil 300 micrometers in thickness.

Separately, fluoroethylene carbonate (hereinafter referred to as “FEC”), ethylene carbonate (hereinafter referred to as “EC”), and ethyl methyl carbonate (hereinafter referred to as “EMC”) were mixed at a volume ratio of 1:1:6 to prepare a non-aqueous solvent.

LiPF₆ was dissolved at a concentration of 1.0 mol/l in the non-aqueous solvent to prepare a non-aqueous electrolyte solution.

A separator was impregnated with the non-aqueous electrolyte solution. The separator was a product manufactured by Celgard, LLC. (product number 2320, 25 micrometers in thickness). This separator was a 3-layer separator composed of a polypropylene layer, a polyethylene layer, and a polypropylene layer.

A coin battery 20 mm in diameter and 3.2 mm in thickness was produced from the positive electrode, the negative electrode, and the separator in a dry box maintained at a dew point of −50° C.

### Reference Example 4-2

### [Production of Positive Electrode Active Material]

In Reference Example 4-2, a mixture of LiF, Li₂MnO₃, LiMnO₂, and LiCoO₂ was prepared such that the Li/Mn/Co/O/F mole ratio was 1.2/0.4/0.4/1.9/0.1.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was subjected to X-ray powder diffractometry.

The space group of the precursor was identified as Fm-3m.

The precursor was then heat-treated at 300° C. for 30 minutes in an air atmosphere. The positive electrode active material according to Reference Example 4-2 was thus prepared.

The positive electrode active material according to Reference Example 4-2 was subjected to powder X-ray diffractometry and electron diffractometry.

The positive electrode active material according to Reference Example 4-2 was identified as a two-phase mixture with a phase belonging to the space group Fm-3m and a phase belonging to the space group R-3m.

The positive electrode active material according to Reference Example 4-2 had an integrated intensity ratio I_{(18°-20°)}/I_{(43°-46°)} of 0.24.

The positive electrode active material according to Reference Example 4-2 was used to produce a coin battery according to Reference Example 4-2 in the same manner as in Reference Example 4-1.

### Reference Example 4-3

### [Production of Positive Electrode Active Material]

In Reference Example 4-3, a mixture of LiF, Li₂MnO₃, LiMnO₂, LiCoO₂, and LiNiO₂ was prepared such that the L/Mn/Co/Ni/O/F mole ratio was 1.2/0.54/0.13/0.13/1.9/0.1.

A 45-ml container containing the mixture and a proper number of zirconia balls 3 mm in diameter was hermetically-sealed in an argon glove box. The container was made of zirconia.

The container was taken out of the argon glove box. The mixture in the container was treated in an argon atmosphere in a planetary ball mill at 600 rpm for 30 hours to prepare a precursor.

The precursor was subjected to X-ray powder diffractometry.

The space group of the precursor was identified as Fm-3m.

The precursor was then heat-treated at 500° C. for 30 minutes in an air atmosphere. The positive electrode active material according to Reference Example 4-3 was thus prepared.

The positive electrode active material according to Reference Example 4-3 was subjected to powder X-ray diffractometry and electron diffractometry.

The positive electrode active material according to Reference Example 4-3 was identified as a two-phase mixture with a phase belonging to the space group Fm-3m and a phase belonging to the space group C2/m.

The positive electrode active material according to Reference Example 4-3 had an integrated intensity ratio I_{(18°-20°)}/I_{(43°-46°)} of 0.30.

The positive electrode active material according to Reference Example 4-3 was used to produce a coin battery according to Reference Example 4-3 in the same manner as in Reference Example 4-1.

### Reference Examples 4-4 to 4-21

In Reference Examples 4-4 to 4-21, a positive electrode active material was prepared in the same manner as in Reference Example 4-1 except for the following items (i) and (ii).

(i) The mixing ratio of the mixture (that is, the mixing ratio of Li/Me/O/F) was changed. See Table 5 for details.

(ii) The firing conditions were changed in the range of 300° C. to 500° C. and in the range of 30 minutes to 2 hours.

The positive electrode active materials according to Reference Examples 4-4 to 4-21 were identified as a two-phase mixture with a phase belonging to the space group Fm-3m and a phase belonging to the space group Fd-3m.

In Reference Examples 4-4 to 4-21, a precursor was prepared in the same manner as in Reference Example 4-1 from the raw materials mixed at the stoichiometric ratio.

The positive electrode active materials according to Reference Examples 4-4 to 4-21 were used to produce coin batteries according to Reference Examples 4-4 to 4-21 in the same manner as in Reference Example 4-1.

### Reference Example 4-22

In Reference Example 4-22, a positive electrode active material with a composition represented by Li_{1.2}Mn_{0.54}Co_{0.13}Ni_{0.13}O₂ was prepared in the same manner as in Reference Example 4-1.

LiF was not used in Reference Example 4-22.

The positive electrode active material according to Reference Example 4-22 was identified as a two-phase mixture with a phase belonging to the space group Fm-3m and a phase belonging to the space group C2/m.

The positive electrode active material according to Reference Example 4-22 had an integrated intensity ratio I_{(18°-20°)}/I_{(43°-46°)} of 0.25.

The positive electrode active material according to Reference Example 4-22 was used to produce a coin battery according to Reference Example 4-22 in the same manner as in Reference Example 4-1.

### Reference Example 4-23

In Reference Example 4-23, a positive electrode active material with a composition represented by the chemical formula LiCoO₂ (lithium cobalt oxide) was produced by a known method.

The positive electrode active material was subjected to X-ray powder diffractometry.

The positive electrode active material according to Reference Example 4-23 had the space group R-3m.

The positive electrode active material according to Reference Example 4-23 had an integrated intensity ratio I_{(18°-20°)}/I_{(43°-46°)} of 1.27.

The positive electrode active material according to Reference Example 4-23 was used to produce a coin battery according to Reference Example 4-23 in the same manner as in Reference Example 4-1.

### Reference Example 4-24

In Reference Example 4-24, a positive electrode active material with a composition represented by Li_{1.2}Mn_{0.8}O_{1.67}F_{0.33} was prepared in the same manner as in Reference Example 4-1.

In Reference Example 4-24, heat treatment was performed at 700° C. for 10 hours.

The positive electrode active material according to Reference Example 4-24 was subjected to X-ray diffractometry and electron diffractometry to analyze the crystal structure.

The positive electrode active material according to Reference Example 4-24 was identified as a two-phase mixture with a phase belonging to the space group Fm-3m and a phase belonging to the space group Fd-3m.

The positive electrode active material according to Reference Example 4-24 had an integrated intensity ratio I_{(18°-20°)}/I_{(43°-46°)} of 1.05.

The positive electrode active material according to Reference Example 4-24 was used to produce a coin battery according to Reference Example 4-24 in the same manner as in Reference Example 4-1.

### Reference Example 4-25

In Reference Example 4-25, a positive electrode active material with a composition represented by Li_{1.2}Mn_{0.8}O_{1.67}F_{0.33} was prepared in the same manner as in Reference Example 4-1.

In Reference Example 4-25, heat treatment was performed at 300° C. for 10 minutes.

The positive electrode active material according to Reference Example 4-25 was subjected to X-ray diffractometry and electron diffractometry to analyze the crystal structure.

The positive electrode active material according to Reference Example 4-25 was identified as a two-phase mixture with a phase belonging to the space group Fm-3m and a phase belonging to the space group Fd-3m.

The positive electrode active material according to Reference Example 4-25 had an integrated intensity ratio I_{(18°-20°)}/I_{(43°-46°)} of 0.02.

The positive electrode active material according to Reference Example 4-25 was used to produce a coin battery according to Reference Example 4-25 in the same manner as in Reference Example 4-1.

### <Evaluation of Battery Performance>

The battery according to Reference Example 4-1 was charged at a current density of 0.5 mA/cm² to a voltage of 4.9 V.

The battery according to Reference Example 4-1 was then discharged at a current density of 0.5 mA/cm² to a voltage of 2.5 V.

The battery according to Reference Example 4-1 had an initial discharge capacity of 299 mAh/g.

The battery according to Reference Example 4-23 was charged at a current density of 0.5 mA/cm² to a voltage of 4.3 V.

The battery according to Reference Example 4-23 was then discharged at a current density of 0.5 mA/cm² to a voltage of 2.5 V.

The battery according to Reference Example 4-23 had an initial discharge capacity of 150 mAh/g.

The initial discharge capacities of the coin batteries according to Reference Examples 4-2 to 4-25 were measured.

Table 5 shows the results.

TABLE 5

| | | | | | | | Initial |
|---|---|---|---|---|---|---|---|
| | | | | | Space group | | discharge |
| | | | | | (other than | \|_{(18°-20°)}/\| | capacity |
| | Average composition | x/y | α/β | (x + y)/(α + β) | Fm-3m) | _{(43°-46°)} | (mAh/g) |
| Reference | Li_{1.2}Mn_{0.8}O_{1.33}F_{0.67} | 1.5 | 2 | 1.0 | Fd-3m | 0.50 | 299 |
| example 4-1 | | | | | | | |
| Reference | Li_{1.2}Mn_{0.4}Co_{0.4}O_{1.9}F_{0.1} | 1.5 | 19 | 1.0 | R-3m | 0.24 | 260 |
| example 4-2 | | | | | | | |
| Reference | Li_{1.2}Mn_{0.54}Co_{0.13}Ni_{0.13}O_{1.9}F_{0.1} | 1.5 | 19 | 1.0 | C2/m | 0.30 | 295 |
| example 4-3 | | | | | | | |
| Reference | Li_{1.2}Mn_{0.8}O_{1.33}F_{0.67} | 1.5 | 2 | 1.0 | Fd-3m | 0.70 | 282 |
| example 4-4 | | | | | | | |
| Reference | Li_{1.2}Mn_{0.8}O_{1.33}F_{0.67} | 1.5 | 2 | 1.0 | Fd-3m | 0.90 | 275 |
| example 4-5 | | | | | | | |
| Reference | Li_{1.2}Mn_{0.8}O_{1.33}F_{0.67} | 1.5 | 2 | 1.0 | Fd-3m | 0.05 | 269 |
| example 4-6 | | | | | | | |
| Reference | Li_{1.2}Mn_{0.8}O_{1.33}F_{0.67} | 1.38 | 2 | 0.95 | Fd-3m | 0.10 | 297 |
| example 4-7 | | | | | | | |
| Reference | Li_{1.2}Mn_{0.8}O_{1.9}F_{0.1} | 1.5 | 19 | 1.0 | Fd-3m | 0.37 | 277 |
| example 4-8 | | | | | | | |
| Reference | Li_{1.2}Mn_{0.75}O_{1.33}F_{0.67} | 1.67 | 2 | 1.0 | Fd-3m | 0.44 | 263 |
| example 4-9 | | | | | | | |
| Reference | Li_{1.2}Mn_{0.75}B_{0.05}O_{1.67}F_{0.33} | 1.5 | 5 | 1.0 | Fd-3m | 0.50 | 293 |
| example 4-10 | | | | | | | |
| Reference | Li_{1.2}Mn_{0.75}P_{0.05}O_{1.67}F_{0.33} | 1.5 | 5 | 1.0 | Fd-3m | 0.50 | 289 |
| example 4-11 | | | | | | | |
| Reference | Li_{1.2}Mn_{0.75}Al_{0.05}O_{1.67}F_{0.33} | 1.5 | 5 | 1.0 | Fd-3m | 0.50 | 290 |
| example 4-12 | | | | | | | |
| Reference | Li_{1.2}Mn_{0.75}Ti_{0.05}O_{1.67}F_{0.33} | 1.5 | 5 | 1.0 | Fd-3m | 0.50 | 289 |
| example 4-13 | | | | | | | |
| Reference | Li_{1.2}Mn_{0.75}Nb_{0.05}O_{1.67}F_{0.33} | 1.5 | 5 | 1.0 | Fd-3m | 0.50 | 281 |
| example 4-14 | | | | | | | |
| Reference | Li_{1.2}Mn_{0.75}W_{0.05}O_{1.67}F_{0.33} | 1.5 | 5 | 1.0 | Fd-3m | 0.50 | 279 |
| example 4-15 | | | | | | | |
| Reference | Li_{1.2}Mn_{0.75}V_{0.05}O_{1.67}F_{0.33} | 1.5 | 5 | 1.0 | Fd-3m | 0.50 | 284 |
| example 4-16 | | | | | | | |
| Reference | Li_{1.2}Mn_{0.75}Cr_{0.05}O_{1.67}F_{0.33} | 1.5 | 5 | 1.0 | Fd-3m | 0.50 | 285 |
| example 4-17 | | | | | | | |
| Reference | Li_{1.2}Mn_{0.75}Si_{0.05}O_{1.67}F_{0.33} | 1.5 | 5 | 1.0 | Fd-3m | 0.50 | 280 |
| example 4-18 | | | | | | | |
| Reference | Li_{1.2}Mn_{0.75}Fe_{0.05}O_{1.67}F_{0.33} | 1.5 | 5 | 1.0 | Fd-3m | 0.50 | 272 |
| example 4-19 | | | | | | | |
| Reference | Li_{1.2}Mn_{0.75}Cu_{0.05}O_{1.67}F_{0.33} | 1.5 | 5 | 1.0 | Fd-3m | 0.50 | 279 |
| example 4-20 | | | | | | | |
| Reference | Li_{1.2}Mn_{0.75}Ru_{0.05}O_{1.67}F_{0.33} | 1.5 | 5 | 1.0 | Fd-3m | 0.50 | 281 |
| example 4-21 | | | | | | | |
| Reference | Li_{1.2}Mn_{0.54}Co_{0.13}Ni_{0.13}O₂ | 1.5 | — | 1.0 | C2/m | 0.25 | 272 |
| example 4-22 | | | | | | | |
| Reference | LiCoO₂ | 1.0 | — | 1.0 | (R-3m) | 1.27 | 150 |
| example 4-23 | | | | | | | |
| Reference | Li_{1.2}Mn_{0.8}O_{1.67}F_{0.33} | 1.5 | 5 | 1.0 | Fd-3m | 1.05 | 254 |
| example 4-24 | | | | | | | |
| Reference | Li_{1.2}Mn_{0.8}O_{1.67}F_{0.33} | 1.5 | 5 | 1.0 | Fd-3m | 0.02 | 252 |
| example 4-25 | | | | | | | |

Table 5 shows that the batteries according to Reference Examples 4-1 to 4-22 have an initial discharge capacity in the range of 260 to 299 mAh/g.

The batteries according to Reference Examples 4-1 to 4-22 have a higher initial discharge capacity than the batteries according to Reference Examples 4-23 to 4-25.

This is probably because the following items (i) and (ii) are satisfied in the batteries according to Reference Examples 4-1 to 4-22.

(i) The lithium composite oxide in the positive electrode active material has a first phase with a crystal structure belonging to the space group Fm-3m and a second phase with a crystal structure belonging to a space group other than the space group Fm-3m.

(ii) In Reference Examples 4-1 to 4-22, the lithium composite oxide has an integrated intensity ratio I_{(18°-20°)}/I_{(43°-46°)} greater than or equal to 0.05 and less than or equal to 0.90.

Satisfying the items (i) and (ii), the lithium composite oxide can intercalate and deintercalate a large amount of Li, has high Li diffusivity, and has a stable crystal structure. This probably greatly improved the initial discharge capacity.

In Reference Example 4-23, the integrated intensity ratio I_{(18°-20°)}/I_{(43°-46°)} is greater than 0.90. In Reference Example 4-23, the crystal structure is a single-phase of the space group R-3m, and therefore the lithium composite oxide does not have a first phase with a crystal structure belonging to the space group Fm-3m. This probably resulted in a decrease in the amounts of intercalated and deintercalated Li while charging and discharging. Furthermore, in Reference Example 4-23, a relatively low mole ratio (x/y) probably resulted in a decreased amount of Li involved in the reaction and a decrease in Li ion diffusivity. For these reasons, this probably greatly reduced the initial discharge capacity.

In Reference Example 4-24, an integrated intensity ratio I_{(18°-20°)}/I_{(43°-46°)} greater than 0.90 probably resulted in a decrease in the abundance ratio of the first phase and a decrease in the amounts of intercalated and deintercalated Li while charging and discharging. Furthermore, it is thought that the formation of many interfaces between the first phase and the second phase decreased the Li diffusivity. This probably decreased the initial discharge capacity.

In Reference Example 4-25, an integrated intensity ratio I_{(18°-20°)}/I_{(43°-46°)} less than 0.05 probably resulted in a low abundance ratio of the second phase and therefore low Li diffusivity. This probably decreased the initial discharge capacity.

Table 5 shows that the battery according to Reference Example 4-2 has a lower initial discharge capacity than the battery according to Reference Example 4-1.

This is probably because, unlike Reference Example 4-1, the second phase in Reference Example 4-2 has a crystal structure not belonging to the space group Fd-3m but belonging to the space group R-3m. A crystal structure belonging to the space group Fd-3m (that is, a spinel structure) has a transition metal anion octahedral three-dimensional network, which functions as a pillar. On the other hand, a crystal structure belonging to the space group R-3m (that is, a layered structure) has a transition metal anion octahedral two-dimensional network, which functions as a pillar. This probably made the crystal structure unstable and decreased the initial discharge capacity.

Table 5 shows that the battery according to Reference Example 4-3 has a lower initial discharge capacity than the battery according to Reference Example 4-1.

This is probably because, unlike Reference Example 4-1, the second phase in Reference Example 4-3 has a crystal structure not belonging to the space group Fd-3m but belonging to the space group C2/m. A crystal structure belonging to the space group Fd-3m (that is, a spinel structure) has a transition metal anion octahedral three-dimensional network, which functions as a pillar. On the other hand, a crystal structure belonging to the space group C2/m (that is, a layered structure) has a transition metal anion octahedral two-dimensional network, which functions as a pillar. This probably made the crystal structure unstable and decreased the initial discharge capacity.

Table 5 shows that the battery according to Reference Example 4-4 has a lower initial discharge capacity than the battery according to Reference Example 4-1.

This is probably because a higher integrated intensity ratio I_{(18°-20°)}/I_{(43°-46°)} in Reference Example 4-4 than in Reference Example 4-1 resulted in a decrease in the abundance ratio of the first phase and a decrease in the amounts of intercalated and deintercalated Li while charging and discharging. It is thought that the formation of many interfaces between the first phase and the second phase decreased the Li diffusivity. This probably decreased the initial discharge capacity.

Table 5 shows that the battery according to Reference Example 4-5 has a lower initial discharge capacity than the battery according to Reference Example 4-4.

This is probably because a higher integrated intensity ratio I_{(18°-20°)}/I_{(43°-46°)} in Reference Example 4-5 than in Reference Example 4-4 resulted in a decrease in the abundance ratio of the first phase and a decrease in the amounts of intercalated and deintercalated Li while charging and discharging. It is thought that the formation of many interfaces between the first phase and the second phase decreased the Li diffusivity. This probably decreased the initial discharge capacity.

Table 5 shows that the battery according to Reference Example 4-6 has a lower initial discharge capacity than the battery according to Reference Example 4-1.

This is probably because a lower integrated intensity ratio I_{(18°-20°)}/I_{(43°-46°)} in Reference Example 4-6 than in Reference Example 4-1 resulted in a decrease in the abundance ratio of the second phase and a decrease in Li diffusivity. This probably decreased the initial discharge capacity.

Table 5 shows that the battery according to Reference Example 4-7 has a lower initial discharge capacity than the battery according to Reference Example 4-1.

This is probably because a lower mole ratio (x/y) in Reference Example 4-7 than in Reference Example 4-1 resulted in an increase in the amount of isolated Li in the crystal structure and a decrease in the amount of Li involved in the reaction. This probably decreased the Li ion diffusivity and decreased the initial discharge capacity.

Table 5 shows that the battery according to Reference Example 4-8 has a lower initial discharge capacity than the battery according to Reference Example 4-1.

This is probably because the mole ratio (a/p) is higher in Reference Example 4-8 than in Reference Example 4-1. In Reference Example 4-8, it is thought that electron delocalization due to a decrease in the effects of electronegative F promotes an oxidation-reduction reaction of oxygen. This probably caused oxygen desorption and made the crystal structure unstable when Li was deintercalated. This probably decreased the initial discharge capacity.

Table 5 shows that the battery according to Reference Example 4-9 has a lower initial discharge capacity than the battery according to Reference Example 4-1.

This is probably because a higher mole ratio (x/y) in Reference Example 4-9 than Reference Example 4-1 resulted in a larger amount of Li deintercalated while charging and made the crystal structure unstable. This probably decreased the initial discharge capacity.

Table 5 shows that the batteries according to Reference Examples 4-10 to 4-21 have a smaller initial discharge capacity than the battery according to Reference Example 4-1.

This is probably because substitution of another element for part of Mn in Reference Examples 4-10 to 4-21 decreased the Mn content compared with Reference Example 4-1. As described above, Mn easily forms a hybrid orbital with oxygen. A decrease in Mn content in Reference Examples 4-10 to 4-21 probably resulted in a decrease in contribution to an oxidation-reduction reaction of oxygen and a decrease in initial discharge capacity.

Table 5 shows that the battery according to Reference Example 4-22 has a smaller initial discharge capacity than the battery according to Reference Example 4-3.

This is probably because the lithium composite oxide in Reference Example 4-22 contains no F. In Reference Example 4-22, no substitution of electronegative F for part of oxygen probably resulted in a decrease in interaction between cations and anions Consequently, it is thought that oxygen desorption while charging at high voltage made the crystal structure unstable and decreased the initial discharge capacity.

A positive electrode active material according to the present disclosure can be utilized as a positive electrode active material for a battery, such as a secondary battery.

What is claimed is:

1. A positive electrode active material comprising:
a lithium composite oxide,
wherein the lithium composite oxide contains
at least one element selected from the group consisting of F, Cl, N, and S, and
at least one element selected from the group consisting of Bi, La, Ce, Ga, Sr, Y, and Sn, and
the following mathematical formula (I) is satisfied:
0.05≤integrated intensity ratio I_{(18°-20°)}/I_{(43°-46°)}≤0.90 (I),
where the integrated intensity ratio I_{(18°-20°)}/I_{(43°-46°)} is a ratio of an integrated intensity I_{(18°-20°)} to an integrated intensity I_{(43°-46°)},
the integrated intensity I_{(43°-46°)} is an integrated intensity of a first peak that is a maximum peak present in a range of angle of diffraction 2θ greater than or equal to 43° and less than or equal to 46° in an X-ray diffraction pattern of the lithium composite oxide, and
the integrated intensity I_{(18°-20°)} is an integrated intensity of a second peak that is a maximum peak present in a range of angle of diffraction 2θ greater than or equal to 18° and less than or equal to 20° in the X-ray diffraction pattern of the lithium composite oxide.

2. The positive electrode active material according to claim 1, wherein the integrated intensity ratio I_{(18°-20°)}/I_{(43°-46°)} is greater than or equal to 0.11 and less than or equal to 0.85.

3. The positive electrode active material according to claim 2, wherein the integrated intensity ratio I_{(18°-20°)}/I_{(43°-46°)} is greater than or equal to 0.44 and less than or equal to 0.85.

4. The positive electrode active material according to claim 1, wherein the lithium composite oxide has a crystal structure belonging to at least one structure selected from the group consisting of a layered structure and a spinel structure.

5. The positive electrode active material according to claim 4, wherein a space group of the layered structure is at least one space group selected from the group consisting of a space group C2/m and a space group R-3m.

6. The positive electrode active material according to claim 1, wherein the lithium composite oxide is a multiphase mixture that has a first phase with a crystal structure belonging to a space group Fm-3m and a second phase with a crystal structure belonging to a space group other than the space group Fm-3m.

7. The positive electrode active material according to claim 6, wherein the crystal structure of the second phase belongs to at least one space group selected from the group consisting of a space group Fd-3m, a space group R-3m, and a space group C2/m.

8. The positive electrode active material according to claim 7, wherein the crystal structure of the second phase belongs to the space group Fd-3m.

9. The positive electrode active material according to claim 1, wherein the lithium composite oxide contains F.

10. The positive electrode active material according to claim 1, wherein the lithium composite oxide contains at least one element selected from the group consisting of Bi, La, and Ce.

11. The positive electrode active material according to claim 10, wherein the lithium composite oxide contains Bi.

12. The positive electrode active material according to claim 1, wherein the lithium composite oxide further contains Mn.

13. The positive electrode active material according to claim 12, wherein the lithium composite oxide further contains Co and Ni.

14. The positive electrode active material according to claim 1, wherein the lithium composite oxide has an average composition represented by a composition formula Liₓ(A_{z}Me_{1-z})_{y}O_{α}Q_{β},
where A denotes at least one element selected from the group consisting of Bi, La, Ce, Ga, Sr, Y, and Sn,
Me denotes at least one element selected from the group consisting of Mn, Co, Ni, Fe, Cu, V, Nb, Mo, Ti, Cr, Zr, Zn, Na, K, Ca, Mg, Pt, Au, Ag, Ru, W, B, Si, P, and Al,
Q denotes at least one element selected from the group consisting of F, Cl, N, and S, and
the following five mathematical formulas are satisfied:
0.5≤x≤1.5,
0.5≤y≤1.0,
0<z≤0.3,
1≤α<2, and
0<β≤1.

15. The positive electrode active material according to claim 14, wherein the following four mathematical formulas are satisfied:
1.05≤x≤1.4,
0.6≤y≤0.95,
1.2≤α<2, and
0<β≤0.8.

16. The positive electrode active material according to claim 15, wherein the following two mathematical formulas are satisfied:
1.33≤α<2, and
0<β≤0.67.

17. The positive electrode active material according to claim 16, wherein the following four mathematical formulas are satisfied:
1.15≤x≤1.3,
0.7≤y≤0.85,
1.8≤α≤1.95, and
0.05≤β≤0.2.

18. A positive electrode active material comprising:
a lithium composite oxide,
wherein the lithium composite oxide has a crystal structure belonging to a space group Fd-3m,
the lithium composite oxide contains at least one element selected from the group consisting of Bi, La, Ce, Ga, Sr, Y, and Sn, and
the following mathematical formula (I) is satisfied:
0.05≤integrated intensity ratio I_{(18°-20°)}/I_{(43°-46°)}≤0.90 (1),
where the integrated intensity ratio I_{(18°-20°)}/I_{(43°-46°)} is a ratio of an integrated intensity I_{(18°-20°)} to an integrated intensity I_{(43°-46°)},
the integrated intensity I_{(43°-46°)} is an integrated intensity of a first peak that is a maximum peak present in a range of angle of diffraction 2θ greater than or equal to 43° and less than or equal to 46° in an X-ray diffraction pattern of the lithium composite oxide, and
the integrated intensity I_{(18°-20°)}is an integrated intensity of a second peak that is a maximum peak present in a range of angle of diffraction 2θ greater than or equal to 18° and less than or equal to 20° in the X-ray diffraction pattern of the lithium composite oxide.

19. A positive electrode active material comprising:
a lithium composite oxide,
wherein the lithium composite oxide is a multiphase mixture that has a first phase with a crystal structure belonging to a space group Fm-3m and a second phase with a crystal structure belonging to a space group other than the space group Fm-3m,
the lithium composite oxide contains at least one element selected from the group consisting of Bi, La, Ce, Ga, Sr, Y, and Sn, and
the following mathematical formula (I) is satisfied:
0.05≤integrated intensity ratio I_{(18°-20°)}/I_{(43°-46°)}≤0.90 (I),
where the integrated intensity ratio I_{(18°-20°)}/I_{(43°-46°)} is a ratio of an integrated intensity I_{(18°-20°)} to an integrated intensity I_{(43°-46°)},
the integrated intensity I_{(43°-46°)} is an integrated intensity of a first peak that is a maximum peak present in a range of angle of diffraction 2θ greater than or equal to 43, and less than or equal to 46° in an X-ray diffraction pattern of the lithium composite oxide, and
the integrated intensity I_{(18°-20°)} is an integrated intensity of a second peak that is a maximum peak present in a range of angle of diffraction 2θ greater than or equal to 18° and less than or equal to 20° in the X-ray diffraction pattern of the lithium composite oxide.

20. The positive electrode active material according to claim 19, wherein the crystal structure of the second phase belongs to at least one space group selected from the group consisting of a space group Fd-3m, a space group R-3m, and a space group C2/m.

21. The positive electrode active material according to claim 20, wherein the crystal structure of the second phase belongs to the space group Fd-3m.

22. The positive electrode active material according to claim 1, wherein the lithium composite oxide is contained as a main component in the positive electrode active material.

23. A battery comprising:
a positive electrode containing the positive electrode active material according to claim 1;
a negative electrode; and
an electrolyte.

24. The battery according to claim 23, wherein the negative electrode contains at least one selected from the group consisting of
(i) a negative-electrode active material that can adsorb and desorb lithium ions and
(ii) a material, wherein lithium metal in the material is dissolved in an electrolyte while discharging and is precipitated on the material while charging, and the electrolyte is a non-aqueous electrolyte solution.

25. The battery according to claim 23, wherein the negative electrode contains at least one selected from the group consisting of
(i) a negative-electrode active material that can adsorb and desorb lithium ions and
(ii) a material, wherein lithium metal in the material is dissolved in an electrolyte while discharging and is precipitated on the material while charging, and the electrolyte is a solid electrolyte.
